(19) United States
(12) Patent Application Publication
(10) Pub. No.: US 2026/0281400 A1
(43) Pub. Date: Sep. 17, 2026

(54) IMAGE PROCESSING APPARATUS AND METHOD

(71) Applicant: Sony Group Corporation, Tokyo (JP)

(72) Inventor: Hironari SAKURAI, Kanagawa (JP)

(73) Assignee: Sony Group Corporation, Tokyo (JP)

(21) Appl. No.: 18/875,736

(22) PCT Filed: Jul. 6, 2023
(86) PCT No.: PCT/JP2023/025065

§ 371 Date: Dec. 17, 2024

(30) Foreign Application Priority Data
Jul. 19, 2022 (JP) 2022-114756

(51) Int. Cl. H04N 19/30; H04N 19/167; H04N 19/172

(52) U.S. Cl. CPC H04N 19/30; H04N 19/167; H04N 19/172

(57) ABSTRACT

The present disclosure relates to image processing apparatus and method that enable a reduction in subjective image quality to be suppressed. A moving image of a predetermined frame size is controlled so that a resolution of a frame image is changed in multiple steps, a reduced image is generated by reducing a size of the frame image of the moving image in accordance with the control, a position of the reduced image to be arranged in a frame of the frame size is set, and the moving image of the frame size including the frame in which the reduced image is arranged at the set position is coded as a single sequence to generate a bitstream. The present disclosure can be applied to, for example, an image processing apparatus or an image processing method.

### TECHNICAL FIELD

The present disclosure relates to image processing apparatus and method and in particular relates to image processing apparatus and method that enable a reduction in subjective image quality to be suppressed.

### BACKGROUND ART

Conventionally, in low-latency real-time transmission of a moving image, a method in which in a case of reducing the resolution of the image in accordance with a reduction of a transmission bandwidth, a reduced image is embedded in a frame without changing the frame size so as to omit insertion of an IDR picture has been devised (e.g., see Patent Literature 1).

### CITATION LIST

### Patent Literature

Patent Literature 1: Japanese Patent Application Laid-open No. 2022-38979

### DISCLOSURE OF INVENTION

### Technical Problem

However, with this method, subjective image quality of the moving image may be significantly reduced due to a resolution suddenly changed in a single frame.

The present disclosure has been made in view of such circumstances to enable a reduction in subjective image quality to be suppressed.

### Solution to Problem

An image processing apparatus according to an aspect of the present technology is an image processing apparatus including: a resolution change control unit that performs control on a moving image of a predetermined frame size so that a resolution of a frame image is changed in multiple steps; an image reduction unit that generates a reduced image by reducing a size of the frame image of the moving image in accordance with the control of the resolution change control unit; a position setting unit that sets a position of the reduced image to be arranged in a frame of the frame size; and a coding unit that codes the moving image of the frame size including the frame in which the reduced image is arranged at the set position as a single sequence to generate a bitstream.

An image processing method according to an aspect of the present technology is an image processing method including: performing control on a moving image of a predetermined frame size so that a resolution of a frame image is changed in multiple steps; generating a reduced image by reducing a size of the frame image of the moving image in accordance with the control; setting a position of the reduced image to be arranged in a frame of the frame size; and coding the moving image of the frame size including the frame in which the reduced image is arranged at the set position as a single sequence to generate a bitstream.

An image processing apparatus according to another aspect of the present technology is an image processing apparatus including: a decoding unit that decodes a bitstream to generate a moving image of a predetermined frame size; a cropping processing unit that crops a reduced image in a frame of the moving image in which the reduced image is arranged, the reduced image being obtained by reducing a size of a partial area of a frame image; and an image enlargement unit that enlarges the cropped reduced image to generate the frame image of the frame size.

An image processing method according to another aspect of the present technology is an image processing method including: decoding a bitstream to generate a moving image of a predetermined frame size; cropping a reduced image in a frame of the moving image in which the reduced image is arranged, the reduced image being obtained by reducing a size of a partial area of a frame image; and enlarging the cropped reduced image to generate the frame image of the frame size.

In the image processing apparatus and method according to the aspects of the present technology, the moving image of the predetermined frame size is controlled so that the resolution of the frame image is changed in multiple steps, the reduced image is generated by reducing the size of the frame image of the moving image in accordance with the control, the position of the reduced image to be arranged in the frame of the frame size is set, and the moving image of the frame size including the frame in which the reduced image is arranged at the set position is coded as the single sequence to generate the bitstream.

In the image processing apparatus and method according to the other aspects of the present technology, the bitstream is decoded to generate the moving image of the predetermined frame size, the reduced image is cropped in the frame of the moving image in which the reduced image is arranged, the reduced image being obtained by reducing the size of the partial area of the frame image, and the cropped reduced image is enlarged to generate the frame image of the frame size.

### BRIEF DESCRIPTION OF DRAWINGS

FIG. 1 A diagram describing resolution switching along with fluctuations of a transmission bandwidth.

FIG. 2 A diagram describing resolution switching along with fluctuations of the transmission bandwidth.

FIG. 3 A diagram showing an example of changing the resolution.

FIG. 4 A diagram showing an example of changing the resolution.

FIG. 5 A diagram showing an example of changing the resolution with a frame size fixed.

FIG. 6 A diagram showing an example of changing the resolution with the frame size fixed.

FIG. 7 A diagram describing a method of controlling a resolution change.

FIG. 8 A diagram showing an example of changing the resolution in frames in multiple steps.

FIG. 9 A diagram showing a control example of a transition pattern.

FIG. 10 A diagram showing an example of changing the resolution in frames in multiple steps.

FIG. 11 A diagram showing a control example of the transition pattern.

FIG. 12 A diagram showing an example of cropping position information.

FIG. 13 A diagram showing an example of changing the resolution in partial areas in multiple steps.

FIG. 14 A diagram showing an example of changing the resolution in partial areas in multiple steps.

FIG. 15 A diagram showing an example of the cropping position information.

FIG. 16 A block diagram showing a main configuration example of an image transmitting apparatus.

FIG. 17 A flowchart showing a flow example of image transmitting processing.

FIG. 18 A block diagram showing a main configuration example of an image receiving apparatus.

FIG. 19 A flowchart showing a flow example of the image receiving processing.

FIG. 20 A block diagram showing a main configuration example of a computer.

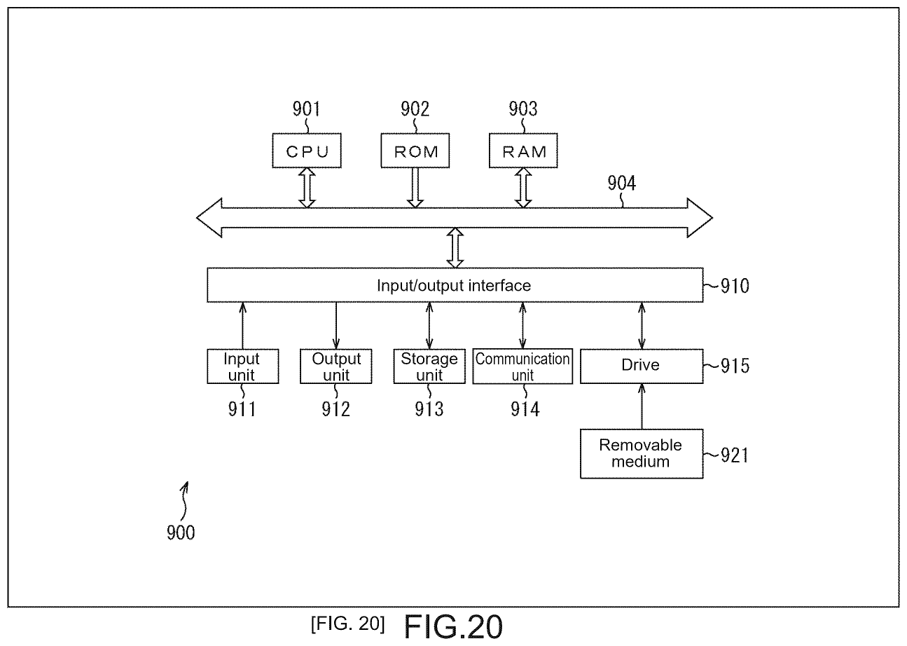

### MODE(S) FOR CARRYING OUT THE INVENTION

Hereinafter, modes for carrying out the present disclosure (hereinafter, referred to as embodiments) will be described. It should be noted that the descriptions will be given in the following order.
1. Documents, etc. that Support Technical Contents and Technical Terminology
2. Resolution Control When Transmitting Moving Image
3. Multi-Step Control of Resolution Change in Frames
4. Multi-Step Control of Resolution Change in Partial Areas
5. First Embodiment (Image Transmitting Apparatus)
6. Second Embodiment (Image Receiving Apparatus)
7. Appendix

### 1. Documents, etc. that Support Technical Contents and Technical Terminology

The scope disclosed by the present technology includes not only the contents described in the embodiments, but also the contents described in Patent Literature and Non-Patent Literatures which are well-known at the date of filing this application.

Patent Literature 1: (mentioned above) Non-Patent Literature 1: Benjamin Bross, Jianle Chen, Shan Liu, Ye-Kui Wang, “Versatile Video Coding (Draft 10),” JVET-S2001-vH, Joint Video Experts Team (JVET) of ITU-T SG 16 WP 3 and ISO/IEC JTC 1/SC29/WG 11 19th Meeting: by teleconference, 22 June-1 Jul. 2020

Non-Patent Literature 2: Recommendation ITU-T H.264 (04/2017) “Advanced video coding for generic audiovisual services,” April 2017

Non-Patent Literature 3: Recommendation ITU-T H.265 (02/18) “High efficiency video coding,” February 2018

That is, the contents described in Patent Literature and Non-Patent Literatures above are also the basis for determining the support requirements. For example, even in a case where a quad-tree block structure, a quad tree plus binary tree (QTBT) block structure described in Non-Patent Literatures above are not directly described in examples, they fall within the disclosure scope of the present technology and meet the support requirements of the scope of claims. Moreover, for example, even in a case where the technology terminology such as parsing, syntax, and semantics are not directly described in examples, they fall within the disclosure scope of the present technology and meet the support requirements of the scope of claims.

Moreover, in the present specification, a “block” (not a block referring to a processing unit) that is used for description as a partial area or unit of processing of an image (picture) indicates any partial area in a picture unless otherwise stated, and there are no limitations on its size, shape, characteristics, and the like. For example, the “block” includes any partial area (unit of processing) such as a transform block (TB), a transform unit (TU), a prediction block (PB), a prediction unit (PU), a smallest coding unit (SCU), a coding unit (CU), a largest coding unit (LCU), a coding tree block (CTB), a coding tree unit (CTU), a conversion block, a sub-block, a macroblock, a tile, or a slice, for example, which are described in Non-Patent Literatures above.

Moreover, for specifying the size of such a block, the block size may be directly specified or the block size may be indirectly specified. The block size may be specified by, for example, using identification information for identifying the size. Moreover, the block size may be specified by, for example, a ratio or difference to/from the size of a reference block (e.g., LCU or SCU). For example, when transmitting information specifying the block size as a syntax element or the like, the information indirectly specifying the size as described above may be used as the information. With this configuration, it may be possible to reduce the amount of information of such information and improve the coding efficiency. Moreover, specifying the block size also includes specifying a range of block sizes (e.g., specifying an allowable range of block sizes).

Moreover, in the present specification, coding includes not only the entire processing of converting an image into a bit stream, but also some of the processing. For example, coding includes not only the processing that encompasses prediction processing, orthogonal transformation, quantization, and arithmetic coding, but also processing that is a general term for quantization and arithmetic coding, processing that encompasses prediction processing, quantization, and arithmetic coding, and the like. Similarly, decoding includes not only the overall processing of converting a bit stream into an image, but also some of the processing. For example, decoding includes not only the overall processing of inverse arithmetic decoding, inverse quantization, inverse orthogonal transformation, and prediction processing, but also the overall processing of inverse arithmetic decoding and inverse quantization, and the overall processing of inverse arithmetic decoding, inverse quantization, and prediction processing, and the like.

### 2. Resolution Control When Transmitting Moving Image

### Low-Latency Real-Time Transmission of Moving Image

Conventionally, a method of coding and transmitting the moving image to reducing the amount of transmitted data because of a large amount of data of the moving image has been devised. As a coding method for the moving image, various methods have been devised as in Non-Patent Literature above.

In recent years, for example, in a system for cloud games, remote driving and operation, remote communication, or the like, it is desirable to immediately (in real time) transmit (also referred to as real-time transmission) a moving image generated by image capturing, image processing, or the like, for example, from a generator side to a viewer side. In general, in such real-time transmission, it is desirable to transmit the moving image stably and with low latency, improve the image quality of the played-back image, and the like in order to realize comfortable operability and the like.

In a coding method for a generally-used moving image, a group of picture (GOP) consisting of a plurality of pictures including an intra picture (I-picture) is formed. That is, in this case, the I-picture is generated per GOP, for example, like IBBPBBIBBPBBI. It should be noted that here, P denotes a predictive picture (P-picture) and B denotes a bidirectionally predictive picture (B-picture). In general, the I-picture is larger in data size than the P-picture or the B-picture. Therefore, there has been a need for providing a buffer of a sufficiently large volume in accordance with the data size of the I-picture on a receiver side. Therefore, there has been a fear that as to the P-picture or the B-picture, the latency amount between generation and playback unnecessarily increases.

In view of this, in order to realize lower-latency transmission (to reduce the latency between generation and playback), a method of reducing the data size of the I-picture to substantially equal that of the P-picture or the B-picture during the coding has been devised. With this configuration, the data sizes of the respective frames are smoothed, so the buffer volume on the receiver side can be reduced and an increase in the latency amount can be suppressed. However, with this method, there has been a fear that the image quality of the played-back image of the I-picture is reduced, corresponding to the amount of reduction in the data size. When the image quality of the I-picture is reduced, the image quality of several subsequent frames (e.g., approximately 5 frames to 10 frames) is also reduced due to the influence of inter-prediction. With this method, the I-picture is generated per GOP, so there has been a fear that the subjective image quality of the moving image played back by decoding the bitstream (image quality that the viewer feels) is significantly reduced.

In view of this, a coding method of setting the I-picture only to the head of the sequence like IPPPPPPP . . . has been devised. The data size of the I-picture is set to substantially equal that of the P-picture as described above. With this method, the I-picture is only the frame at the head of the sequence, so the image quality of the played-back image is reduced only in several frames near the head of the sequence. The reduction in the subjective image quality of the played back moving image can be suppressed as compared to a case where a typical GOP is formed as described above.

By the way, the bandwidth of the transmission channel for transmitting the bitstream is not constant. For example, in a case where a transmission channel is shared with other communication like the Internet or the like, the bandwidth of the transmission channel can fluctuate depending on a status and the like of the other communication.

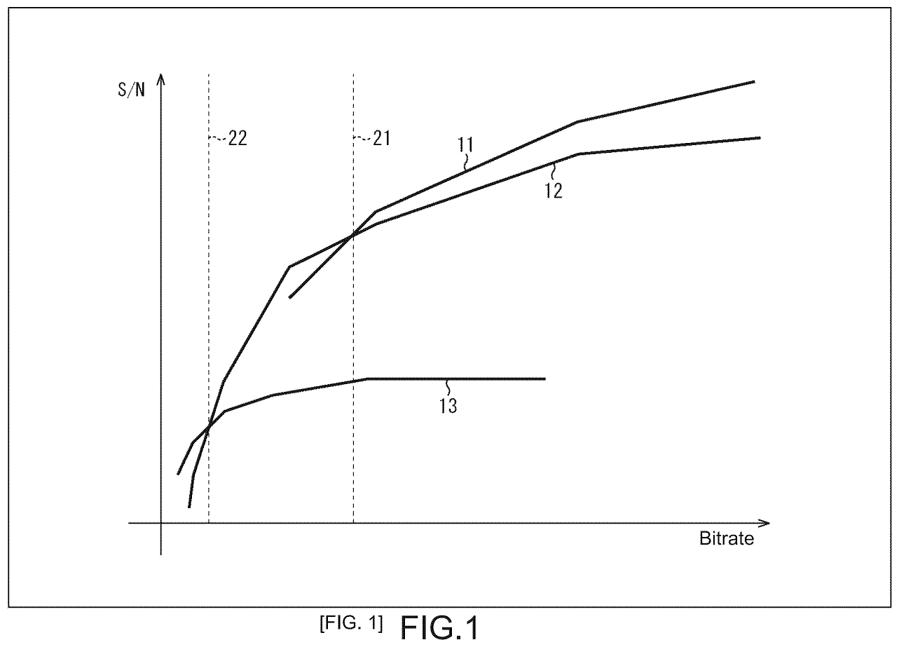

In view of this, a method of controlling the resolution of the moving image in accordance with bandwidth fluctuations of the transmission channel and the like in order to improve the image quality of the played-back image as much as possible and to prevent interruption of transmission of the moving image and an increase in the latency has been devised. The graph in FIG. 1 shows a relationship between the transmission rate (bit rate) and the image quality (signal/noise (S/N)) of the played-back image. A curve line 11 shows a relationship between the transmission rate and the image quality of the played-back image when transmitting a high-resolution moving image. A curve line 12 shows a relationship between the transmission rate and the image quality of the played-back image when transmitting a medium-resolution moving image. A curve line 13 shows a relationship between the transmission rate and the image quality of the played-back image when transmitting a low-resolution moving image.

As shown in FIG. 1, in a case where the transmission rate is higher than a dotted line 21, a played-back image with the highest image quality can be obtained by transmitting the high-resolution moving image. In a case where the transmission rate is between the dotted line 21 and a dotted line 22, the played-back image with the highest image quality can be obtained by transmitting the medium-resolution moving image. In a case where the transmission rate is lower than the dotted line 22, the played-back image with the highest image quality can be obtained by transmitting the low-resolution moving image.

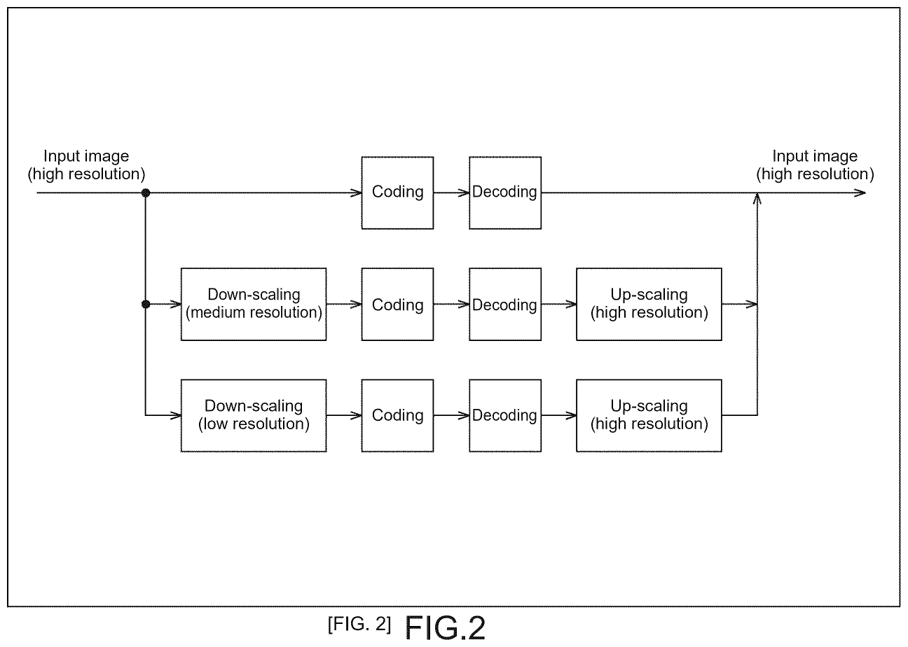

As shown in FIG. 2, when transmitting the high-resolution moving image, a high-resolution input image is coded and transmitted and is decoded on the receiver side. When transmitting the medium-resolution moving image, an input image is coded and transmitted after scaling it down to have a medium resolution. The medium-resolution moving image obtained by decoding on the receiver side is scaled up to have a high resolution. When transmitting the low-resolution moving image, an input image is coded and transmitted after scaling it down to have a low resolution. The low-resolution moving image obtained by decoding on the receiver side is scaled up to have a high resolution.

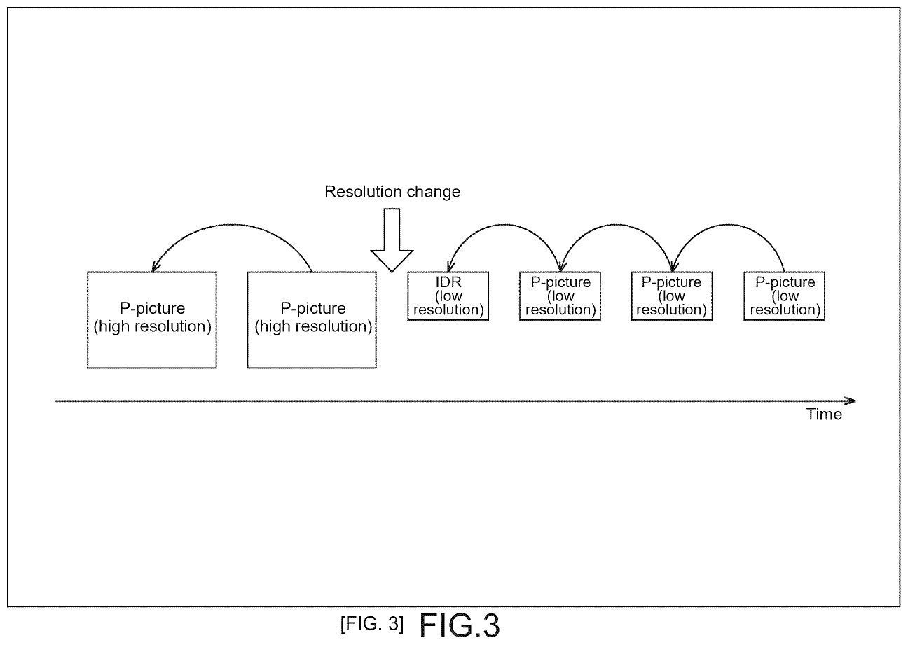

It should be noted that with this method, when changing the resolution, the sequence is cut and coding processing is terminated and restarted (i.e., it becomes another stream). The reference plane cannot be taken over at such a cut line of the sequence. For example, in FIG. 3, the squares indicate some frames (pictures) of the moving image. As shown in the thick-line arrows, the respective frames are arranged in a chronological order (playback order) from the left to the right in the figure. In such a moving image, for example, when the resolution is changed at a timing as shown by the white arrow, the sequence is interrupted and the reference plane cannot be taken over in that frame, so it becomes necessary to insert an instantaneous decoder refresh (IDR) picture (I-picture). Therefore, there has been a fear that as in a case of forming the above-mentioned GOP, the image quality of the played-back image is reduced at the resolution change timing and the image quality reduction propagates to several frames.

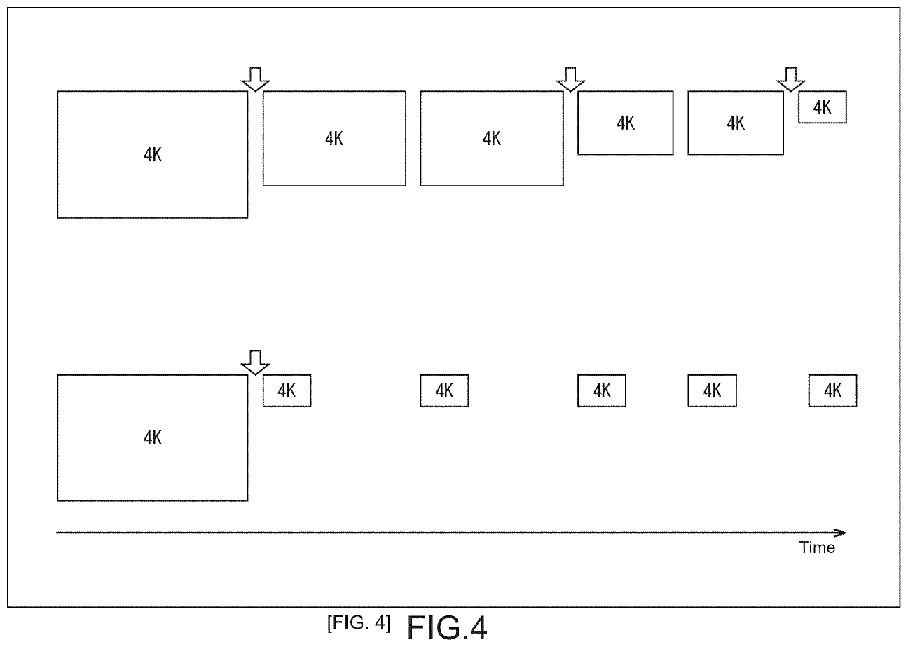

That is, when the resolution is repeatedly changed in the moving image as in the white arrows in the example shown in the upper part of FIG. 4, the sequence is interrupted every time the resolution is changed and the image quality of several frames is reduced, so there has been a fear that the image quality is reduced for a long period. Moreover, when the resolution is significantly reduced in a single resolution change as in the example in the lower part of FIG. 4, the frequency of switching is less, but a gap of the resolution is larger, so there has been a fear that a change in the image quality is noticeable. That is, in either case, there has been a fear that the subjective image quality of the played back moving image is significantly reduced.

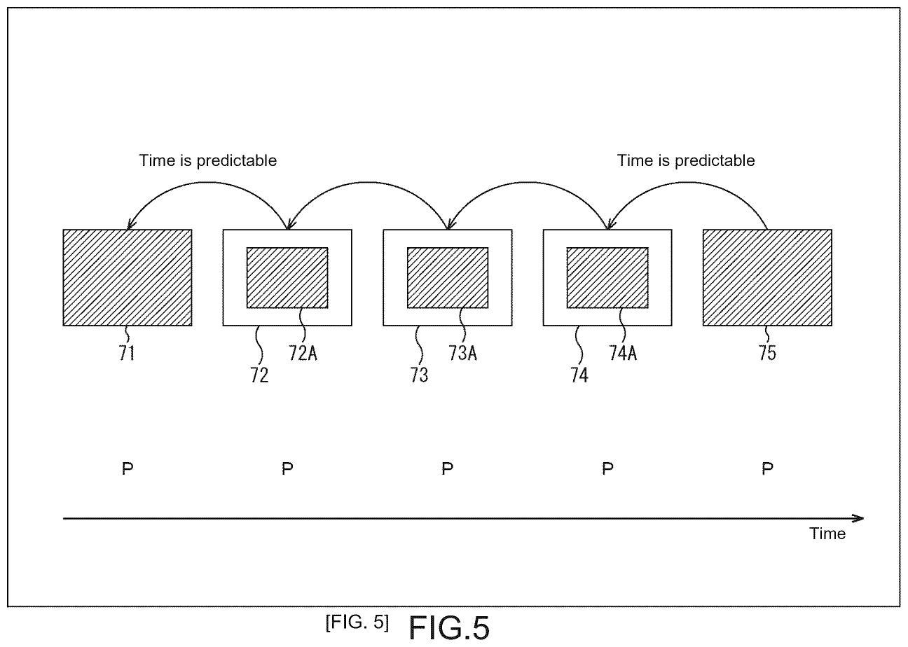

In view of this, as described in Patent Literature 1, a method of changing the resolution with the frame size fixed has been devised. FIG. 5 is a diagram showing a state example of the resolution change according to the method. Also in FIG. 5, as in FIG. 3, frames 71 to 75 indicate some frames (pictures) of the moving image. The hatching patterns of the respective frames indicate image portions. As shown by the thick-line arrows, the respective frames are arranged from the left to the right in the figure in the chronological order (playback order).

In a case of this example of the moving image in FIG. 5, the frame image (hatched portion) is reduced in size in the frame 72 and a reduced image 72A is arranged in the frame 72. The frame 73 is also processed as in the frame 72 and a reduced image 73A is arranged in the frame 73. The frame 74 is also processed as in the frame 72 and a reduced image 74A is arranged in the frame 74. In the frame 75, the size reduction of the image is terminated. During playback, the reduced images of the frames 72 to 74 are cropped from the frames and enlarged to have the frame size.

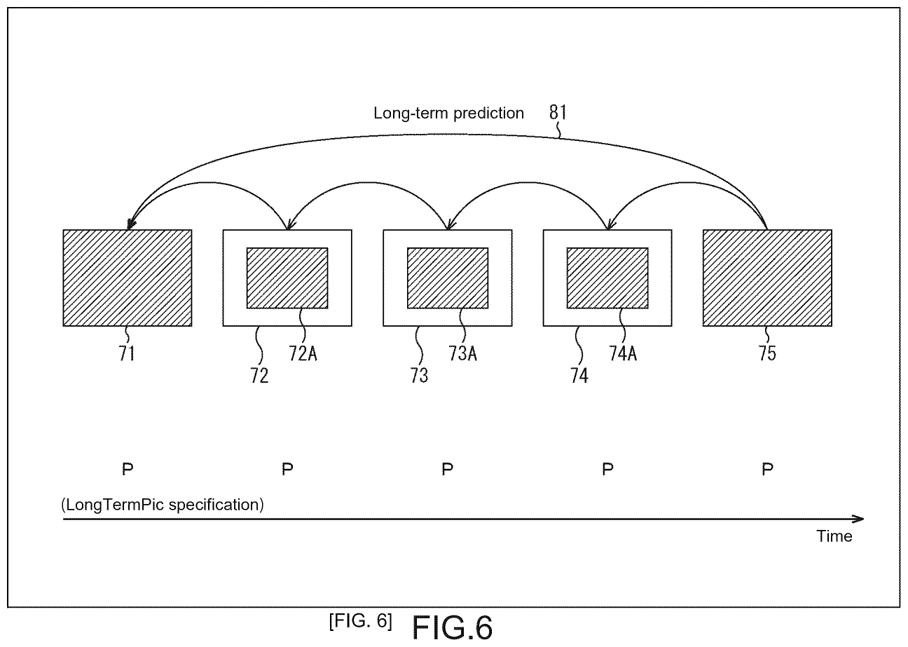

By fixing the frame size in this manner, it is possible to continue the sequence and change the resolution. That is, it is possible to set P-pictures to the frames 71 to 75 and continue time prediction (inter-prediction) as shown by the arrows between the respective frames. That is, the resolution can be changed without using the IDR picture (I-picture). Therefore, a reduction in the image quality of the played-back image due to the resolution change (insertion of the IDR picture) can be suppressed. It should be noted that by applying long-term prediction and referring to the frames 75 to 71 as shown by the arrow 81 in the example in FIG. 6, a reduction of the prediction accuracy in the frame 75 can be suppressed.

However, in this method, the resolution is changed once (in a single frame). Therefore, there has been a fear that a change in the image quality clearly appears in the played-back image, for example, in a case where the resolution is significantly changed. Moreover, there has been a fear that in that case, the prediction accuracy of the inter-prediction is significantly reduced, so the reduction of the image quality also increases. In this manner, there has been a fear that a reduction in the subjective image quality of the played back moving image increases due to an increase in the amount of change in the resolution. In addition, there has been a fear that when the occurrence frequency of significant bandwidth fluctuations of the transmission channel increases, the occurrence frequency of the image quality reduction increases in the played-back image and a reduction in the subjective image quality of the played back moving image further increases.

### 3. Multi-Step Control of Resolution Change in Frames

### Method 1

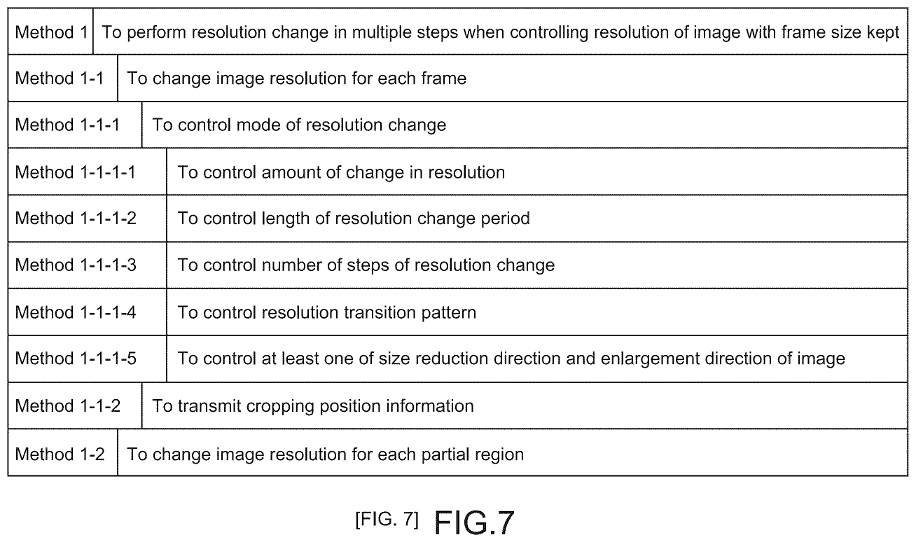

In view of this, the resolution is changed in multiple steps when controlling the resolution of the image (Method 1) with the frame size kept as shown in the first line in the table in FIG. 7. It should be noted that hereinafter, the change in the resolution means changing resolution settings with respect to a previous unit of processing (e.g., a previous frame) (i.e., changing the size reduction rate of the image) rather than enlarging or reducing the image (rather than processing the image itself). It should be noted that the processing of increasing/reducing the resolution of the image is equivalent to the processing of enlarging/reducing the image (size).

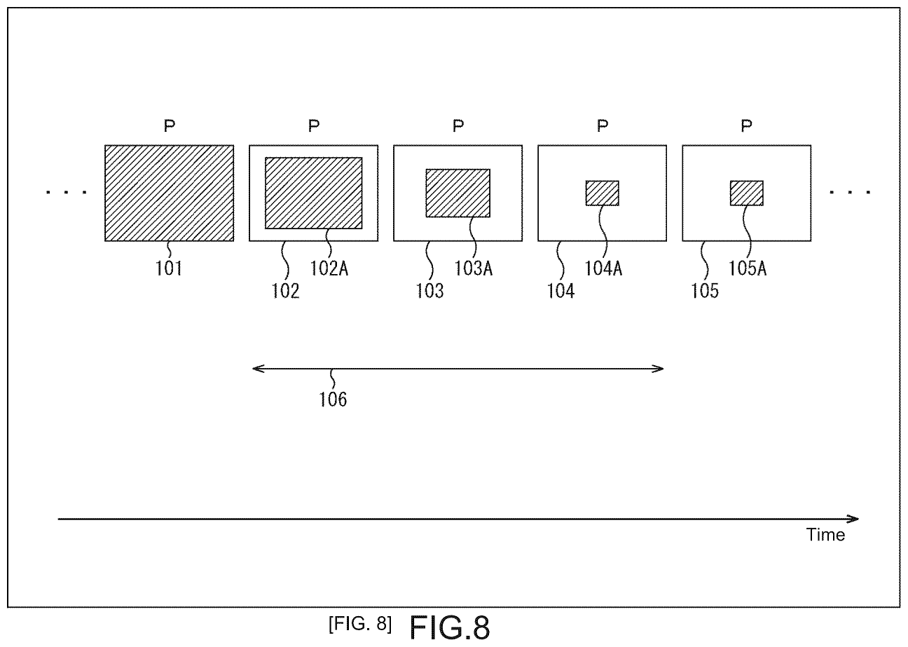

FIG. 8 is a diagram showing a state example of the resolution change according to the method. Also in FIG. 8, as in FIG. 5, the frames 101 to 105 indicate some frames (pictures) of the moving image. The hatching patterns of the respective frames indicate image portions. As shown by the thick-line arrows, the respective frames are arranged from the left to the right in the figure in the chronological order (playback order). Also in the method shown in FIG. 8, the resolutions of the respective frame images are changed with the frame size fixed as in the example in FIG. 5. It should be noted that in a case of the method in FIG. 8, the resolution change is performed in multiple steps (i.e., for the plurality of frames).

For example, the frame 101 has the frame image of the frame size. In contrast, a reduced image 104A obtained by reducing the size of the frame image to have a size smaller than the frame size is arranged in the frame 104. In this manner, in a case where (the resolution of) the frame image is reduced from the frame size to the size of the reduced image 104A, the size is reduced once (in a single frame) in the method (FIG. 5) described in Patent Literature 1. For example, in a case of starting the resolution change in the frame 102, the frame image is reduced to have the size of the reduced image 104A in the frame 102.

In contrast, in the example in FIG. 8, the size of the frame image is changed from the frame size to the size of the reduced image 104A for three frames, the frames 102 to 104. That is, the resolution is changed in the frames 102 to 104. It should be noted that the reduced image 105A of the frame 105 has the same size (same resolution) as the reduced image 104A (the resolution is not changed).

In the frame 102, a reduced image 102A obtained by reducing the size of the frame image to be a size smaller than the frame size is arranged. In the frame 103, a reduced image 103A obtained by reducing the size of the frame image to be a size smaller than the reduced image 102A is arranged. The reduced image 104A is smaller than the reduced image 103A. That is, in a case of this example, the resolution of the frame image is changed in three steps (in a reduction direction to be described later). By changing the resolution in multiple steps (divided in a plurality of steps) in this manner, the resolution difference between the respective frames can be reduced.

Therefore, a reduction in the prediction accuracy of the inter-prediction can be suppressed, and a reduction in the image quality of the played-back image can be suppressed. Moreover, subjectively, the resolution change becomes unnoticeable because the resolution difference between the frames is reduced. That is, a reduction in subjective image quality of the moving image can be suppressed.

### Method 1-1

It should be noted that the resolution change may be performed on any data unit of image as long as it is a data unit capable of independently coding and decoding in the frame. For example, in a case where Method 1 is applied as shown in the 2nd line from above in the table in FIG. 7, the resolution change may be performed for each frame (Method 1-1). That is, the resolution change of the entire frame image may be performed in multiple steps.

### Method 1-1-1

Moreover, any mode of the resolution change (e.g., in how many steps a change is made, for how many frames a change is made, by how much degree the resolution is changed, etc.) can be employed as long as the resolution change is performed in multiple steps. For example, this mode may be defined in advance. Moreover, in a case where Method 1-1 described above is applied as shown in the 3rd line from above in the table in FIG. 7, the mode of the resolution change may be controlled (Method 1-1-1). That is, with respect to the resolution change of the entire frame image performed in multiple steps, the mode of the resolution change may be controlled.

For example, on a transmitter side of the moving image, the image processing apparatus may include a resolution change control unit that performs control on a moving image of a predetermined frame size so that a resolution of a frame image is changed in multiple steps, an image reduction unit that generates a reduced image by reducing a size of the frame image of the moving image in accordance with the control of the resolution change control unit, a position setting unit that sets a position of the reduced image to be arranged in the frame of the frame size, and a coding unit that codes the moving image of the frame size including the frame in which the reduced image is arranged at the set position as a single sequence to generate a bitstream. At that time, the resolution change control unit may control the change in the resolution of the entire frame image. Moreover, for example, the image processing method may include performing control on a moving image of a predetermined frame size so that a resolution of a frame image is changed in multiple steps, generating a reduced image by reducing a size of the frame image of the moving image in accordance with the control, setting a position of the reduced image to be arranged in a frame of the frame size, and coding the moving image of the frame size including the frame in which the reduced image is arranged at the set position as a single sequence to generate a bitstream. At that time, the change in the resolution of the entire frame image may be controlled.

For example, on a receiver side of the moving image, the image processing apparatus may include a decoding unit that decodes a bitstream to generate a moving image of a predetermined frame size, a cropping processing unit that crops a reduced image in a frame of the moving image in which the reduced image is arranged, the reduced image being obtained by reducing a size of a frame image, and an image enlargement unit that enlarges the cropped reduced image to generate the frame image of the frame size. Moreover, the image processing method may include decoding a bitstream to generate a moving image of a predetermined frame size, cropping a reduced image in a frame of the moving image in which the reduced image is arranged, the reduced image being obtained by reducing a size of a frame image, and enlarging the cropped reduced image to generate the frame image of the frame size.

At that time, the reduced image may be one obtained by reducing the size of the entire frame image. For example, the image enlargement unit may generate the frame image of the frame size by enlarging the reduced image of the entire frame image. At that time, the image enlargement unit only needs to enlarge the reduced image to have the frame size in a case where the frame image is reduced in size with respect to each frame. The image enlargement method (method of increasing the resolution) is optional. For example, the image enlargement method may be determined in advance.

Moreover, the transmitter side of the moving image (resolution change control unit) may control the mode of the resolution change of the entire frame image at any timing in frames. For example, the resolution change control unit may perform this control for each frame or may perform this control for each plurality of frames. Moreover, the resolution change control unit may regularly perform this control or may irregularly perform this control. For example, the resolution change control unit may perform this control on the basis of any conditions such as bandwidth fluctuations of the transmission channel. It should be noted that as described above, the resolution is changed for the plurality of frames. That is, the resolution change for an amount corresponding to the plurality of frames is controlled by a single control. Therefore, a case where the control of the resolution is changed again during the period when the resolution is changed is conceived. In such a case, the subsequent control may be prioritized. That is, the resolution change contents may be overwritten by the subsequent control. For example, in a case where the contents are updated in the second frame of the resolution change for three frames, the resolution in the first frame is changed in accordance with the previous control contents and the resolution in the second frame and the following frames is changed in accordance with the subsequent control contents. That is, the resolution is changed for four frames. Moreover, new control of the resolution change may be prevented during the period in which the resolution is changed. It should be noted that the receiver side of the moving image (image enlargement unit) enlarges the image in accordance with final resolution change contents (contents reflecting the overwriting).

### Method 1-1-1-1

Any control contents of the mode of the resolution change may be employed. For example, in a case where Method 1-1-1 described above is applied as shown in the 4th line from above in the table in FIG. 7, the amount of change in the resolution may be controlled (Method 1-1-1-1). That is, when changing the resolution, to what extent the resolution is finally changed may be controlled. For example, as in FIG. 8, in a case of reducing the frame image from the frame size to the size of the reduced image 104A, the size (resolution) of the reduced image 104A may be variable (be capable of being set).

For example, the transmitter side of the moving image (resolution change control unit) may control the amount of change in the resolution. At that time, the resolution change control unit may control the amount of change in the resolution on the basis of any information. For example, the resolution change control unit may control the amount of change in accordance with the bandwidth of the transmission channel. For example, in a case where the bandwidth fluctuations of the transmission channel are large, the size (resolution) of the reduced image after the resolution change may be reduced, and in a case where the bandwidth fluctuations of the transmission channel are small, the size (resolution) after the resolution change may be increased.

With this configuration, a necessary and sufficient resolution change can be performed. For example, the latency can be prevented from occurring because the size (resolution) of the reduced image after the resolution change is too large with respect to the bandwidth of the transmission channel. Moreover, the image quality can be prevented from unnecessarily being reduced because the size (resolution) of the reduced image after the resolution change is too small with respect to the bandwidth of the transmission channel.

### Method 1-1-1-2

Moreover, in a case where Method 1-1-1 described above is applied as shown in the 5th line from above in the table in FIG. 7, the length of the resolution change period may be controlled (Method 1-1-1-2). That is, when changing the resolution, for how many frames the resolution is changed may be controlled. For example, as in FIG. 8, in a case of reducing the frame image from the frame size to the size of the reduced image 104A, four frames shown by the double arrow 106 is the resolution change period in which the resolution changes. The length of the resolution change period may be variable (be capable of being set). For example, the transmitter side of the moving image (resolution change control unit) may control the length of the change period of the resolution. It is sufficient that the resolution change period is the number of frames larger than the number of steps of the resolution change. That is, in all frames in the resolution change period, the resolution of the frame image does not need to be changed (the size of the frame image may be identical to that of the previous frame).

At that time, the length of the change period of the resolution may be controlled on the basis of any information. For example, the resolution change control unit may control the length of the change period in accordance with the degree of change in the bandwidth of the transmission channel. For example, the resolution change control unit may shorten the resolution change period in a case where the bandwidth fluctuations of the transmission channel are sudden and may prolong the resolution change period in a case where the bandwidth fluctuations of the transmission channel are gentle. With this configuration, the resolution change control unit is capable of changing the resolution more adaptively to the bandwidth of the transmission channel and is capable of more efficiently using the bandwidth of the transmission channel. That is, a reduction in the image quality of the played-back image can be suppressed.

Moreover, for example, in accordance with the contents of the content, the length of the resolution change period may be controlled. For example, the resolution change control unit may control the length of the change period in accordance with (the contents of) the moving image to be transmitted. For example, the resolution change control unit may shorten the resolution change period in a case where the influence of the resolution change on the subjective image quality is small, like at the head of the sequence, the time of scene switching, or the like, and may prolong the resolution change period in a case where the influence of the resolution change on the subjective image quality is large, like a game screen operated by the user, a scene for which the image quality is important, or the like. With this configuration, the resolution change control unit is capable of changing the resolution more adaptively to the contents of the content and is capable of suppressing the influence on the subjective image quality of the moving image.

### Method 1-1-1-3

Moreover, in a case where Method 1-1-1 described above is applied as shown in the 6th line from above in the table in FIG. 7, the number of steps of the resolution change may be controlled (Method 1-1-1-3). That is, when changing the resolution, in how many steps the resolution is changed may be controlled. For example, in a case of FIG. 8, the resolution is changed in three steps (reduced images 102A to 104A) from the frame size to the size of the reduced image 104A. This number of steps may be variable (be capable of being set). For example, the transmitter side of the moving image (resolution change control unit) may control the number of steps of the resolution change. It is sufficient that this number of steps is two or more steps. For example, by increasing the number of steps, the resolution difference between the frames can be reduced. Accordingly, a reduction in the prediction accuracy of the inter-prediction can be suppressed, and a reduction in the image quality of the played-back image can be suppressed. Moreover, subjectively, the resolution change becomes unnoticeable in the played-back image because the resolution difference between the frames is reduced. That is, a reduction in subjective image quality of the moving image can be suppressed. Moreover, the resolution change period cannot be the number of frames smaller than the number of steps, so the resolution can be changed for a shorter period by reducing the number of steps.

It should be noted that this control may be set in accordance with the control of the amount of change in the resolution and the length of the resolution change period which have been described above, the transition pattern of the resolution to be described later, and the like.

### Method 1-1-1-4

Moreover, in a case where Method 1-1-1 described above is applied as shown in the 7th line from above in the table in FIG. 7, how to change the resolution (also referred to as a transition pattern) may be controlled (Method 1-1-1-4). That is, when changing the resolution, how the resolution changes in the resolution change period may be controlled. In other words, the resolution of the image for each frame in the resolution change period may be controlled. For example, in a case of FIG. 8, the resolution of the reduced image 102A and the reduced image 103A in the resolution change period (double arrow 106) may be variable (be capable of being set). For example, the transmitter side of the moving image (resolution change control unit) may control the transition pattern of the resolution in the change in the resolution.

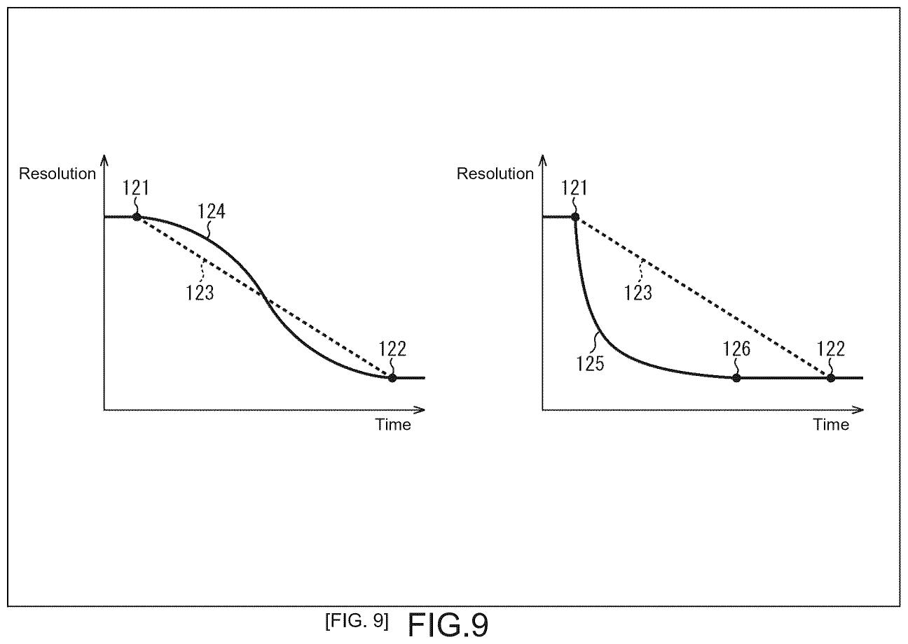

This transition pattern is optional. The resolution may be transitioned in any pattern in the change period. For example, in the graph shown on the left side in FIG. 9, in a case of reducing the resolution from a point 121 to a point 122, the resolution of the frame image between them may be linearly changed as shown by the dotted line 123 or may be non-linearly changed as shown by the curve line 124. By controlling the transition pattern of the resolution in this manner, for example, even with the same change period, it is possible to advance the resolution change (significantly change the resolution earlier in the period) or to delay the resolution change (significantly change the resolution at the last part in the period). Moreover, for example, by changing the resolution as shown by the curve line 124, it is possible to more smoothly change the resolution (make the change in the size reduction rate of the image smoother) as compared to changing the resolution as shown by the dotted line 123. Therefore, the start and end of the resolution change can be made more unnoticeable subjectively in the played-back image. In this manner, a more adaptive resolution change can be realized.

It should be noted that the control method for this transition pattern is optional. For example, an optimal one may be selected from a plurality of candidate transition patterns prepared in advance or an optimal transition pattern may be derived by arithmetic operation or the like.

At that time, the transition pattern of the resolution may be controlled on the basis of any information. For example, the resolution change control unit may control the transition pattern of the resolution in accordance with the degree of change in the bandwidth of the transmission channel. Moreover, for example, the resolution change control unit may control the transition pattern of the resolution in accordance with (the contents of) the moving image to be transmitted. With this configuration, it is possible to change the resolution more adaptively to the bandwidth of the transmission channel, the contents of the content, and the like.

### Combination, etc.

Parameters to be controlled in the control related to the resolution change are optional, and are not limited to the above-mentioned examples (Method 1-1-1-1 to Method 1-1-1-4). Moreover, in the control related to the resolution change, the control of a plurality of parameters may be used in combination. For example, any two or more of Method 1-1-1-1 to Method 1-1-1-4 described above may be applied in combination. Moreover, one or more of the various types of methods described above may be combined with the control of its other parameters.

For example, at the time of controlling the transition pattern of the resolution, the resolution change period may be also changed. For example, in the graph shown on the right side in FIG. 9, in a case of reducing the resolution from the point 121 to the point 122, the resolution of the frame image between them may be linearly changed as shown by the dotted line 123 or may be non-linearly changed as shown by the curve line 125 to be the same resolution as the point 122 at the time of the frame shown as a point 126. That is, in a case of the transition pattern of the curve line 125, the resolution change period in a case of the transition pattern of the dotted line 123 which has been from the frame of the point 121 to the frame of the point 122 is shorten from the frame of the point 121 to the frame of the point 126.

### Control of Image Enlargement Direction

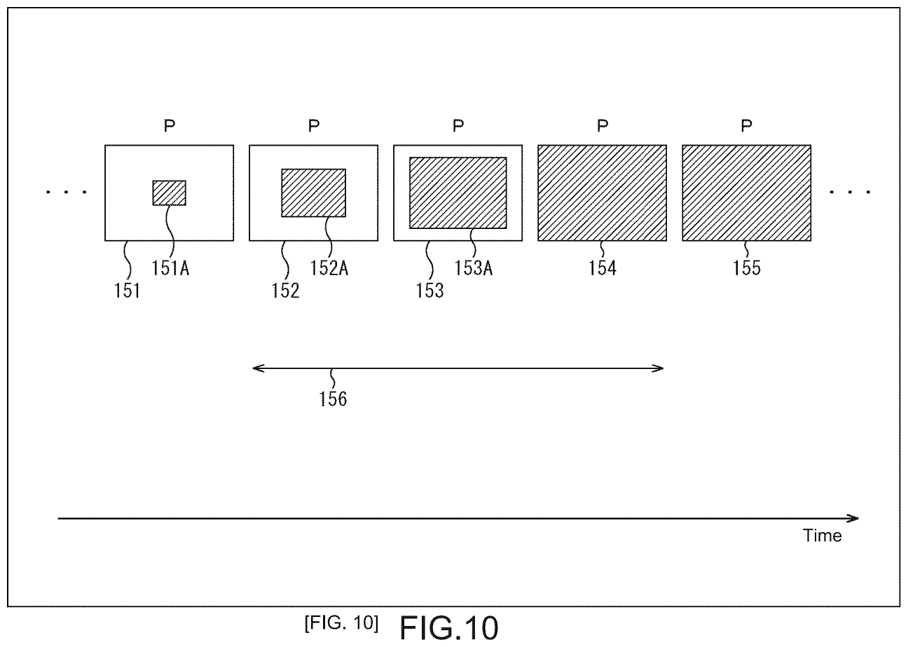

Hereinabove, the control of the resolution change in the direction of reducing the resolution of the frame image along the time series (the direction of increasing the reduction rate of the frame image along the time series) (also referred to as the reduction direction) has been described, though the mode of the resolution change to be controlled is optional and is not limited to this example. For example, as shown in FIG. 10, the resolution change in the direction of increasing the resolution of the frame image along the time series (the direction of reducing the reduction rate of the frame image along the time series) (also referred to as an enlargement direction) may be controlled.

FIG. 10 is a diagram showing a state example of the resolution change in the enlargement direction of the image. Also in FIG. 10, as in FIG. 8, the frames 151 to 155 indicate some frames (pictures) of the moving image. The hatching patterns of the respective frames indicate image portions. As shown by the thick-line arrows, the respective frames are arranged from the left to the right in the figure in the chronological order (playback order). Also in a case of this example, as in the example in FIG. 8, the resolution of each frame image with the frame size fixed is changed and the resolution change is performed in multiple steps (i.e., for the plurality of frames).

It should be noted that in a case of the example in FIG. 10, in opposite to the example in a case of FIG. 8, the size of the frame image is changed from the size of the reduced image 151A to the frame size for three frames of the frames 152 to 154. That is, the resolution is changed in the frames 152 to 154. It should be noted that the size of the frame image of the frame 155 is identical to the frame size and is the same as the frame 154 (the resolution is not changed).

In the frame 151, the reduced image 151A whose frame image is reduced in size to have a size smaller than the frame size is arranged. In the frame 152, the reduced image 152A whose frame image is reduced in size to have a size larger than the reduced image 151A is arranged. In the frame 153, the reduced image 153A whose frame image is reduced in size to have a size larger than the reduced image 152A is arranged. The frame images of the frame 154 and the frame 155 are not reduced in size, and their size is identical to the frame size.

That is, in a case of this example, the resolution of the frame image is changed in three steps in the enlargement direction. The present technology can also be applied to the resolution change in such an enlargement direction as in a case of the resolution change in the reduction direction described above. That is, also in a case of the resolution change in the enlargement direction, as shown in the first line in the table in FIG. 7, the resolution change may be performed in multiple steps when controlling the resolution of the image with the frame size kept by applying Method 1. By changing the resolution in multiple steps (divided in a plurality of steps) in this manner, as in a case of the reduction direction described above, the resolution difference between the frames can be reduced. Therefore, a reduction in the prediction accuracy of the inter-prediction can be suppressed, and a reduction in the image quality of the played-back image can be suppressed. Moreover, subjectively, the resolution change becomes unnoticeable because the resolution difference between the frames is reduced. That is, a reduction in subjective image quality of the moving image can be suppressed.

Moreover, in a case where Method 1 is applied to the resolution change in the enlargement direction, the resolution change may be performed for each frame (Method 1-1) as shown in the 2nd line from above in the table in FIG. 7. That is, the resolution change of the entire frame image may be performed in multiple steps. Moreover, in a case where Method 1-1 is applied to the resolution change in the enlargement direction, the mode of the resolution change may be controlled (Method 1-1-1) as shown in the 3rd line from above in the table in FIG. 7. That is, with respect to the resolution change of the entire frame image, which is performed in multiple steps, the mode of the change may be controlled.

Moreover, in a case where Method 1-1-1 is applied to the resolution change in the enlargement direction, the amount of change in the resolution may be controlled (Method 1-1-1-1) as shown in the 4th line from above in the table in FIG. 7. That is, when changing the resolution, to what extent the resolution is finally changed may be controlled. Moreover, in a case where Method 1-1-1 is applied to the resolution change in the enlargement direction, the length of the resolution change period may be controlled (Method 1-1-1-2) as shown in the 5th line from above in the table in FIG. 7. That is, when changing the resolution, for how many frames the resolution is changed may be controlled. Moreover, in a case where Method 1-1-1 is applied to the resolution change in the enlargement direction, the number of steps of the resolution change may be controlled (Method 1-1-1-3) as shown in the 6th line from above in the table in FIG. 7. That is, when changing the resolution, in how many steps the resolution is changed may be controlled. Moreover, in a case where Method 1-1-1 is applied to the resolution change in the enlargement direction, the transition pattern of the resolution (Method 1-1-1-4) may be controlled as shown in the 7th line from above in the table in FIG. 7. That is, when changing the resolution, how the resolution changes in the resolution change period may be controlled. In other words, the resolution of the image for each frame in the resolution change period may be controlled.

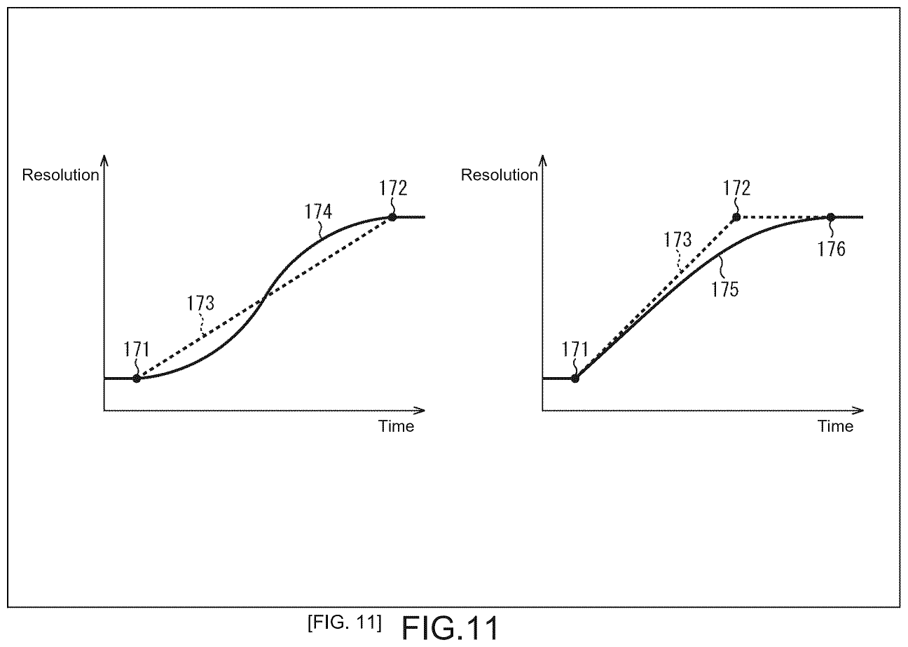

For example, in the graph shown on the left side in FIG. 11, in a case of reducing the resolution from the point 171 to the point 172, the resolution of the frame image between them may be linearly changed as shown by the dotted line 173 or may be non-linearly changed as shown by the curve line 174.

Moreover, also in a case of the resolution change in the enlargement direction, as in a case of the resolution change in the reduction direction, the parameters to be controlled in the control related to the resolution change are optional and are not limited to the above-mentioned examples (Method 1-1-1-1 to Method 1-1-1-4). Moreover, in the control related to the resolution change, the control of a plurality of parameters may be used in combination. For example, any two or more of Method 1-1-1-1 to Method 1-1-1-4 described above may be applied in combination.

Moreover, one or more of the various types of methods described above may be combined with the control of its other parameters.

For example, in the graph shown on the right side in FIG. 11, in a case of increasing the resolution from the point 171 to the point 176, the resolution of the frame image between them may be linearly changed as shown by the dotted line 173 or may be non-linearly changed as shown by the curve line 175 to have the same resolution as the point 172 at the time of the frame shown as the point 176. That is, in a case of the transition pattern of the curve line 175, the resolution change period in a case of the transition pattern of the dotted line 173 which has been from the frame of the point 171 to the frame of the point 172 is extended from the frame of the point 171 to the frame of the point 176.

Also in a case of applying any method to the resolution change in the enlargement direction, effects similar to those of the resolution change in a case of the reduction direction described above can be obtained.

### Method 1-1-1-5

In the single sequence, the resolution change in the reduction direction described above and the resolution change in the enlargement direction can both exist. In such a case, the control of the resolution change may be performed in both directions of the reduction direction and the enlargement direction or may be performed in either one. That is, in a case where Method 1-1-1 described above is applied as shown in the 8th line from above in the table in FIG. 7, at least one of the size reduction direction and the enlargement direction of the image may be controlled (Method 1-1-1-5). That is, both of the example in FIG. 8 and the example in FIG. 10 may be realized or either one may be realized. For example, the transmitter side of the moving image (resolution change control unit) may control in multiple steps at least one of an increase (image size reduction direction) and a reduction (image enlargement direction) in the amount of change in the resolution in a time-series direction.

It should be noted that in a case of performing both the control of the mode of the resolution change in the reduction direction and the control of the mode of the resolution change in the enlargement direction, both control may be performed independently of each other. That is, one control may be performed, not depending on the other control. For example, in a case of controlling the amount of change in the resolution, the resolution change period, the number of steps, the transition pattern, and the like, in each of the control of the mode of the resolution change in the reduction direction and the control of the mode of the resolution change in the enlargement direction, those parameters may be set independently of each other. Moreover, the parameters to be controlled may be different from each other.

Moreover, in a case of performing both the control of the mode of the resolution change in the reduction direction and the control of the mode of the resolution change in the enlargement direction, one control may depend on the other control. For example, the mode of the resolution change in the reduction direction and the mode of the resolution change in the enlargement direction may be symmetric. For example, the amount of change in the resolution, the length of the resolution change period, the number of steps, and the like may be made identical to each other between the resolution change in the reduction direction and the resolution change in the enlargement direction and the transition pattern may be opposite in orientation. For example, in a case where the resolution is linearly changed as shown by the dotted line 123 in the left graph in FIG. 9 in the resolution change in the reduction direction, the resolution may be linearly changed as shown by the dotted line 173 in the left graph in FIG. 11 also in the resolution change in the enlargement direction. Moreover, in a case where the resolution is non-linearly changed as shown by the curve line 124 in the left graph in FIG. 9 in the resolution change in the reduction direction, the resolution may be non-linearly changed as shown by the curve line 174 in the left graph in FIG. 11 also in the resolution change in the enlargement direction.

Moreover, control may be performed so that the period of the resolution change in the reduction direction is longer than the period of the resolution change in the enlargement direction without exception. On the contrary, control may be performed so that the period of the resolution change in the reduction direction is shorter than the period of the resolution change in the enlargement direction without exception. Moreover, control may be performed so that the total length of the period of the resolution change in the reduction direction and the period of the resolution change in the enlargement direction is constant.

### Transmission of Resolution Change Information

It should be noted that the image enlargement from the transmitter side of the moving image to the receiver side of the moving image may be controlled. For example, by transmitting the resolution change information indicating the control contents about the change in the resolution from the transmitter side of the moving image to the receiver side of the moving image, this control may be realized. For example, the transmitter side of the moving image (resolution change control unit) may generate the resolution change information indicating the control contents about the change in the resolution and the transmitter side of the moving image (coding unit) may code the moving image whose resolution change has been controlled to generate a bitstream and contain the resolution change information in the bitstream.

In contrast, the receiver side of the moving image (image enlargement unit) may enlarge the cropped reduced image from the frame on the basis of the resolution change information and generate a frame image of a predetermined frame size. For example, in the resolution change information, the enlargement method for the reduced image to be applied (method of increasing the resolution) may be specified or the enlargement method for the reduced image to be applied may be derived on the basis of information indicated by the resolution change information. It should be noted that the resolution change information only needs to be associated with the moving image and does not need to be contained in the bitstream (may be data other than the bitstream).

Moreover, the resolution change information may be one generated by another apparatus (e.g., a server or the like) other than the apparatus on the transmitter side of the moving image.

### Method 1-1-2

The reduced image in which the frame image is reduced in size is arranged in its frame as described with reference to FIG. 8 and the like. This position is optional as long as it is in the frame. It may be a position defined in advance or the position may be variable. In a case where at least one of the position of the reduced image and the resolution is variable (capable of being controlled), the apparatus on the receiver side of the moving image needs to grasp where the reduced image is located in the frame in order to crop the reduced image from the frame. In view of this, the cropping position information indicating the position for cropping the reduced image from the frame may be transmitted from the transmitter side to the receiver side of the moving image (Method 1-1-2) as shown in the 9th line from above in the table in FIG. 7.

For example, the transmitter side of the moving image (position setting unit) may generate cropping position information indicating a position of the reduced image that it has set and the transmitter side of the moving image (coding unit) may code the moving image whose resolution change has been controlled to generate a bitstream and contain the cropping position information in the bitstream. In contrast, the receiver side of the moving image (cropping processing unit) may crop the reduced image from the frame on the basis of the cropping position information.

By transmitting the cropping position information in this manner, the cropping processing unit is capable of more easily and more correctly grasping the position and the size of the reduced image arranged in the frame (i.e., which part in the frame should be cropped) on the basis of the cropping position information. That is, the cropping processing unit is capable of more easily and more correctly cropping the reduced image.

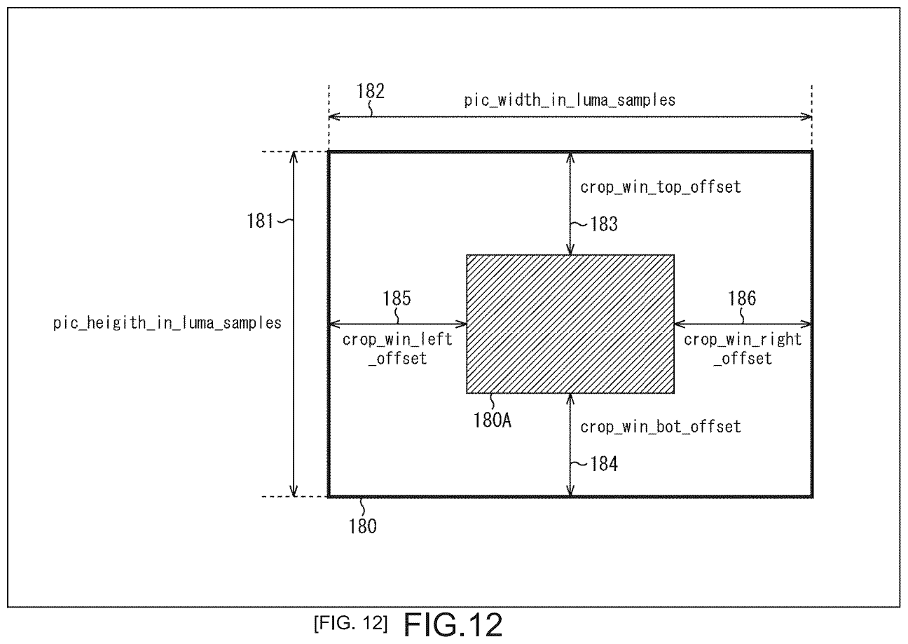

It should be noted that specifications of the cropping position information are optional and any information may be included as long as the cropping position of the reduced image is indicated. For example, the cropping position information may include top, bottom, left, and right offsets of the arranged reduced image. FIG. 12 is a diagram showing an example of the parameters included in the cropping position information. In FIG. 12, an example of the cropping position information in a case where a reduced image 180A is arranged in a frame 180.

In a case of the example in FIG. 12, the cropping position information includes pic_height_in_luma_samples indicating a frame height (double arrow 181) and pic_width_in_luma_samples indicating a frame width (double arrow 182). Moreover, the cropping position information includes crop_win_top_offset indicating an offset (double arrow 183) of the arranged reduced image 180A in a top direction, crop_win_bot_offset indicating an offset (double arrow 184) of the arranged reduced image 180A in a bottom direction, crop_win_left_offset indicating an offset (double arrow 185) of the arranged reduced image 180A in the left direction, and crop_win_right_offset indicating an offset (double arrow 186) of the arranged reduced image 180A in the right direction. That is, in a case of this example, the range for cropping in the frame is shown by the offsets in top, bottom, left, and right directions from the frame ends of the reduced image.

In addition, the cropping position information may include, for example, the information indicating the position of the range for cropping in the frame and the information indicating the size of the cropping range. For example, the cropping position information may include offsets from the frame ends of the reduced image in the top direction and the left direction (information indicating the position of the cropping range) and the information indicating the height and the width of the cropping range. Moreover, the information indicating the position of the cropping range may be indicated by coordinates (e.g., center coordinates or the like) of a predetermined position of the cropping range.

In a case of storing the cropping position information as described above in the bitstream, a method for storing it is optional. For example, in a case where the coding method for the moving image is high efficiency video coding (HEVC), the cropping position information may be stored in supplemental enhancement information (SEI) (user data unregistered SEI) storing the user data. In that case, the cropping position information may be stored, associated with the frame. For example, the cropping position information such as the above-mentioned frame size, offsets, and the like, may be stored in SEI, associated with picture order count (POC) of the frame.

### 4. Multi-Step Control of Resolution Change in Partial Areas

### Method 1-2

In a case where Method 1 is applied as shown in the bottom line of the table in FIG. 7, the resolution change may be performed for each partial area in the frame (Method 1-2). That is, the resolution change of the frame image partial area may be performed in multiple steps. Although the partial area may be any area as long as it is a part of the frame image, an area that can be coded and decoded independently of another portion, like a slice, a tile, or the like, for example, HEVC or versatile video coding (VVC), is desirable.

### Application of Method 1-1-1

It should be noted that also with this method 1-2, as in the case of Method 1-1, the mode of the resolution change (e.g., in how many steps a change is made, for how many frames a change is made, by how much degree the resolution is changed, etc.) is optional as long as it is performed in multiple steps. For example, this mode may be defined in advance. Moreover, also in a case where the Method 1-2 is applied, Method 1-1-1 may be applied. That is, with respect to the resolution change of the entire frame image, which is performed in multiple steps, the mode of the change may be controlled.

For example, on the transmitter side of the moving image, the image processing apparatus may include a resolution change control unit that performs control on a moving image of a predetermined frame size so that a resolution of a frame image is changed in multiple steps, an image reduction unit that generates a reduced image by reducing a size of the frame image of the moving image in accordance with the control of the resolution change control unit, a position setting unit that sets a position of the reduced image to be arranged in the frame of the frame size, and a coding unit that codes the moving image of the frame size including the frame in which the reduced image is arranged at the set position as a single sequence to generate a bitstream. At that time, the resolution change control unit may control a resolution change of the partial area of the frame image. Moreover, for example, the image processing method may include performing control on a moving image of a predetermined frame size so that a resolution of a frame image is changed in multiple steps, generating a reduced image by reducing a size of the frame image of the moving image in accordance with the control, setting a position of the reduced image to be arranged in a frame of the frame size, and coding the moving image of the frame size including the frame in which the reduced image is arranged at the set position as a single sequence to generate a bitstream. At that time, the change in the resolution of the entire frame image may be controlled.

For example, on the receiver side of the moving image, the image processing apparatus may include a decoding unit that decodes a bitstream to generate a moving image of a predetermined frame size, a cropping processing unit that crops a reduced image in a frame of the moving image in which the reduced image is arranged, the reduced image being obtained by reducing a size of a partial area of a frame image, and an image enlargement unit that enlarges the cropped reduced image to generate the frame image of the frame size. Moreover, the image processing method may include decoding a bitstream to generate a moving image of a predetermined frame size, cropping a reduced image in a frame of the moving image in which the reduced image is arranged, the reduced image being obtained by reducing a size of a partial area of a frame image, cropping the reduced image, and enlarging the cropped reduced image to generate the frame image of the frame size.

That is, the image enlargement unit may generate the image of the partial area in the frame of the frame size by enlarging the reduced image of the partial area of the frame image and may generate the frame image of the frame size by using the image of the partial area. At that time, in a case where the image of the partial area is reduced in size with respect to each frame, the image enlargement unit only needs to enlarge the reduced image to the size of the partial area. The image enlargement method (method of increasing the resolution) is optional. For example, the image enlargement method may be determined in advance.

Moreover, in a case of controlling the resolution change of the partial area of the frame image in this manner (in a case where Method 1-1-1 is applied to Method 1-2), as in a case of controlling the resolution change of the entire frame image, the transmitter side of the moving image (resolution change control unit) may control the mode of the resolution change of the partial area of the frame image described above at any timing in frames. For example, the resolution change control unit may control the resolution change for a certain partial area for each frame or may control the resolution change for each plurality of frames. Moreover, the resolution change control unit may regularly perform this control or may irregularly perform this control. Moreover, the resolution change contents may be overwritten by the subsequent control. Moreover, during the period in which the resolution is changed, new control of the resolution change may be configured not to be performed. It should be noted that the receiver side of the moving image (image enlargement unit) enlarges the image in accordance with final resolution change contents (contents reflecting the overwriting).

### Resolution Change Control Example 1

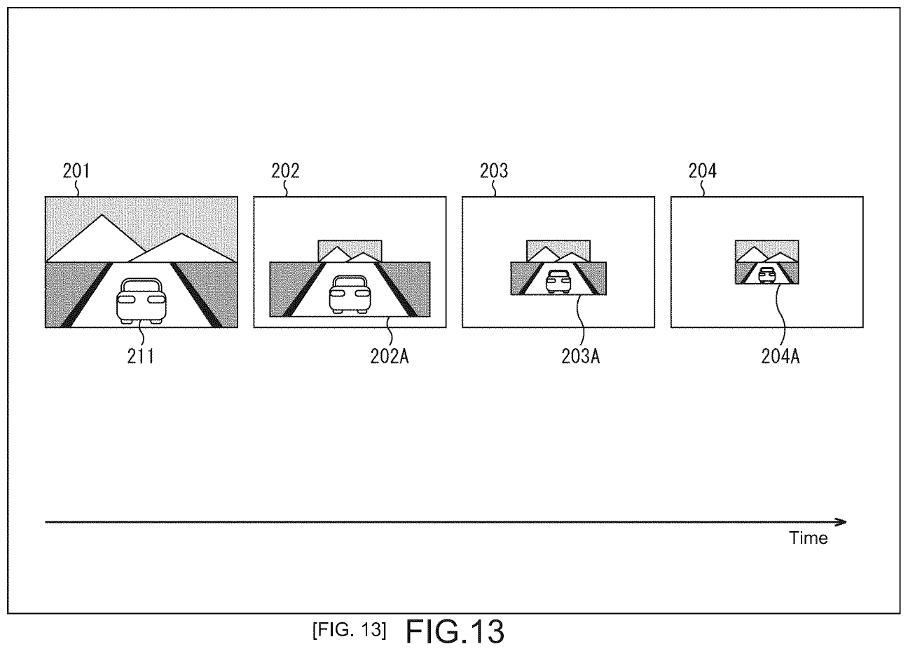

FIG. 13 is a diagram showing a state example of the control of the resolution change for each partial area. Also in FIG. 13, as in FIG. 8, the frames 201 to 204 indicate some frames (pictures) of the moving image. As shown by the thick-line arrows, the respective frames are arranged from the left to the right in the figure in the chronological order (playback order). Also in a case of this example, as in the example in FIG. 8, the resolution of each frame image with the frame size fixed is changed and the resolution change is performed in multiple steps (i.e., for the plurality of frames).

It should be noted that in a case of the example in FIG. 13, the resolution change is performed for each partial area. For example, it is assumed that this moving image is a game screen and the user is operating (driving) an automobile 211 so that the automobile 211 does not go off the road. Moreover, it is assumed that the upper half of each frame image is a distant view of a mountain and the like and the lower half is a close view including the automobile 211 and the road. In such a case, the user is mainly focusing on the lower half of the frame image. Moreover, the distant view may be an image with weak edges which is slightly out of focus as compared to the close view. Therefore, from the user's subjective perspective, an image quality change is likely to be more noticeable in the area (close view) of the lower half than in the area (distant view) of the upper half of the frame image. In other words, the user is more unlikely to notice an image quality change in the area (distant view) of the upper half of the frame image than an image quality change in the area (close view) of the lower half of the frame image.

In view of this, the resolution may be significantly varied in the area with a smaller subjective influence for suppressing the amount of coding and the resolution may be slowly varied in the area with a larger subjective influence. That is, a distributor side (resolution change control unit) of the moving image may control the change in the resolution of the partial area in accordance with the image of the partial area. In the example in FIG. 13, the resolution of the area (distant view) of the upper half of the frame image is varied significantly (earlier (for a shorter period) ) than that of the area (close view) of the lower half of the frame image. Specifically, the resolution of the area (distant view) of the upper half of the frame image is reduced to the same resolution as a reduced image 204A of a frame 204 at a time of a reduced image 202A of a frame 202. In contrast, the resolution of the area (close view) of the lower half of the frame image is gradually reduced for three frames, the frames 202 to 204.

That is, the amount of coding is changed by a resolution change of mainly the area where the influence on the subjective image quality is relatively small. Therefore, also in a case where the transmission rate of the moving image is varied more drastically, an increase of the influence of the resolution change on the subjective image quality can be suppressed.

It should be noted that although in the example in FIG. 13, the area of the upper half of the frame image and the area of the lower half are changed to have the same resolution, the resolution of each area may be changed so that the area of the upper half of the frame image and the area of the lower half have different resolutions (sizes), for example, as in the reduced image 202A or the reduced image 203A.

### Resolution Change Control Example 2

For example, in a case of controlling the resolution change of the moving image in accordance with bandwidth fluctuations of the transmission channel, the bandwidth fluctuations of the transmission channel do not always occur at the start timing of processing on the head of the frame image. In other words, the bandwidth fluctuations of the transmission channel can occur at a timing while the frame image is processed. In a case of controlling the resolution change of the entire frame image, even if new fluctuations occur in the bandwidth of the transmission channel during the processing of the frame image, the fluctuations are coped with in a next frame.

In view of this, the resolution change may be enabled to be started from a midway point of the frame image. That is, the distributor side of the moving image (resolution change control unit) may perform control so that the resolution is changed from the partial area corresponding to the timing of the bandwidth fluctuations of the transmission channel.

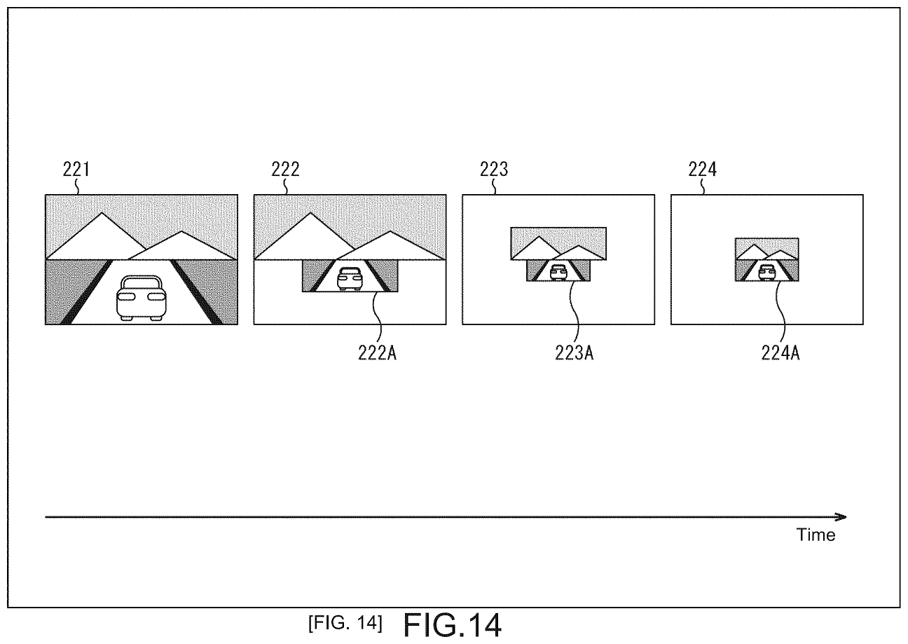

FIG. 14 is a diagram showing a state example of the control of the resolution change for each partial area. Also in FIG. 14, as in FIG. 13, the frames 221 to 224 indicate some frames (pictures) of the moving image. As shown by the thick-line arrows, the respective frames are arranged from the left to the right in the figure in the chronological order (playback order). Also in a case of this example, as in the example in FIG. 13, the resolution of each frame image with the frame size fixed is changed for each partial area and the resolution change is performed in multiple steps (i.e., for the plurality of frames).

In a case of the example in FIG. 14, the resolution change of the moving image is controlled in accordance with bandwidth fluctuations of the transmission channel and a resolution change is started from the area of the lower half of a frame 222. Therefore, the resolution is changed in the frame 222 and a frame 223 with respect to the area of the lower half of the frame image. Meanwhile, the resolution is changed in the frame 223 and a frame 224 with respect to the area of the upper half of the frame image.

With this configuration, also with respect to new bandwidth fluctuations of the transmission channel during the processing of such a frame image, the change in the resolution can be controlled without waiting for a next frame (from a next partial area). That is, it is possible to control the change in the resolution immediately (in real time) to cope with the new bandwidth fluctuations. That is, it is possible to change the resolution more adaptively to the bandwidth fluctuations of the transmission channel. Accordingly, it is possible to transmit the moving image by using the bandwidth of the transmission channel more efficiently, so transmission with higher image quality can be realized. That is, a reduction in subjective image quality of the moving image can be suppressed.

It should be noted that also in a case of the example in FIG. 14, as in a case of the example in FIG. 13, the resolution of each area may be changed so that the area of the upper half of the frame image and the area of the lower half have different resolutions (sizes).

### Application of Method 1-1-1-1

Moreover, also in a case of the resolution change for each partial area, as in a case of the resolution change of the entire frame image, any control contents may be employed for the mode. For example, also in a case where Method 1-2 is applied, the amount of change in the resolution may be controlled by applying Method 1-1-1-1 described above. That is, when changing the resolution, to what extent the resolution is finally changed may be controlled. With this configuration, a necessary and sufficient resolution change can be performed.

### Application of Method 1-1-1-2

Moreover, also in a case where Method 1-2 is applied, the length of the resolution change period may be controlled by applying Method 1-1-1-2 described above. That is, when changing the resolution, for how many frames the resolution is changed may be controlled. At that time, the length of the change period of the resolution may be controlled on the basis of any information. For example, the resolution change control unit may control the length of the change period in accordance with the degree of change in the bandwidth of the transmission channel. Moreover, for example, the resolution change control unit may control the length of the change period in accordance with (the contents of) the moving image to be transmitted. With this configuration, it is possible to realize a resolution change more adaptive to the bandwidth of the transmission channel, the contents of the content, and the like and to suppress the influence on the subjective image quality of the moving image.

### Application of Method 1-1-1-3

Moreover, also in a case where Method 1-2 is applied, the number of steps of the resolution change may be controlled by applying Method 1-1-1-3 described above. That is, when changing the resolution, in how many steps the resolution is changed may be controlled. With this configuration, it is possible to suppress a reduction in subjective image quality of the moving image and to change the resolution for a shorter period. It should be noted that this control may be set in accordance with the control of the amount of change in the resolution and the length of the resolution change period which have been described above, the transition pattern of the resolution to be described later, and the like.

### Application of Method 1-1-1-4

Moreover, also in a case where Method 1-2 is applied, how to change the resolution (the transition pattern) may be controlled by applying Method 1-1-1-4 described above. That is, when changing the resolution, how the resolution changes in the resolution change period may be controlled. In other words, the resolution of the image for each frame in the resolution change period may be controlled.

Also in a case of controlling the resolution change of the partial area of the frame image, as in a case of controlling the resolution change of the entire frame image, this transition pattern is optional. The resolution may be transitioned in any pattern in the change period. With this configuration, a more adaptive resolution change can be realized. It should be noted that the control method for this transition pattern is optional. For example, an optimal one may be selected from a plurality of candidate transition patterns prepared in advance or an optimal transition pattern may be derived by arithmetic operation or the like. At that time, the transition pattern of the resolution may be controlled on the basis of any information. For example, the resolution change control unit may control the transition pattern of the resolution in accordance with the degree of change in the bandwidth of the transmission channel. Moreover, for example, the resolution change control unit may control the transition pattern of the resolution in accordance with (the contents of) the moving image to be transmitted. With this configuration, it is possible to change the resolution more adaptively to the bandwidth of the transmission channel, the contents of the content, and the like.

### Application of Combination, Etc.

As in a case of the resolution change of the entire frame image, also in the resolution change of the partial area, the parameters to be controlled are optional and are not limited to the above-mentioned examples (Method 1-1-1-1 to Method 1-1-1-4). Moreover, the control of a plurality of parameters may be used in combination. For example, any two or more of Method 1-1-1-1 to Method 1-1-1-4 described above may be applied in combination. Moreover, one or more of the various types of methods described above may be combined with the control of its other parameters.

### Control of Image Enlargement Direction

As in a case of the resolution change of the entire frame image, also in the resolution change of the partial area, the resolution change in the enlargement direction may be controlled. In that case, as in a case of the resolution change in the reduction direction described above, various methods can be applied. Also in a case of applying any method to the resolution change in the enlargement direction, effects similar to those of the resolution change in a case of the reduction direction described above can be obtained.

### Application of Method 1-1-1-5

Moreover, also in a case where Method 1-2 is applied, at least one of the size reduction direction and the enlargement direction of the image may be controlled by applying Method 1-1-1-5 described above. That is, the transmitter side of the moving image (resolution change control unit) may perform control so that at least one of an increase (image size reduction direction) and a reduction (image enlargement direction) of the amount of change in the resolution in the time-series direction with respect to the partial area is performed in multiple steps.

It should be noted that in a case of performing both the control of the mode of the resolution change in the reduction direction and the control of the mode of the resolution change in the enlargement direction, the both control may be performed independently of each other. That is, one control may be performed, not depending on the other control. Moreover, one control may depend on the other control.

### Transmission of Resolution Change Information

It should be noted that as in a case of the resolution change of the entire frame image, also in the resolution change of the partial area, the image enlargement from the transmitter side of the moving image to the receiver side of the moving image may be controlled. For example, by transmitting the resolution change information indicating the control contents about the change in the resolution from the transmitter side of the moving image to the receiver side of the moving image, this control may be realized. For example, the transmitter side of the moving image (resolution change control unit) may generate the resolution change information indicating the control contents about the change in the resolution and the transmitter side of the moving image (coding unit) may code the moving image whose resolution change has been controlled to generate a bitstream and contain the resolution change information in the bitstream.

In contrast, the receiver side of the moving image (image enlargement unit) may enlarge the cropped reduced image on the basis of resolution change information indicating the control contents about the change in the resolution of the reduced image. For example, in the resolution change information, the enlargement method for the reduced image to be applied (method of increasing the resolution) may be specified or the enlargement method for the reduced image to be applied may be derived on the basis of information indicated by the resolution change information. It should be noted that as described above, the resolution change information may be contained in the bitstream of the moving image. That is, the receiver side of the moving image (image enlargement unit) may enlarge the reduced image on the basis of the resolution change information contained in the bitstream.

It should be noted that the resolution change information only needs to be associated with the moving image and does not need to be contained in the bitstream (may be data other than the bitstream). Moreover, the resolution change information may be one generated by another apparatus (e.g., a server or the like) other than the apparatus on the transmitter side of the moving image.

### Application of Method 1-1-2

Moreover, also in a case where Method 1-2 is applied, the cropping position information indicating the position for cropping the reduced image from the frame may be transmitted from the transmitter side to the receiver side of the moving image by applying Method 1-1-2 described above. That is, as in a case of the resolution change of the entire frame image, also in the resolution change of the partial area, the cropping position information may be transmitted.

For example, the transmitter side of the moving image (position setting unit) may generate the cropping position information indicating the position of the reduced image of the partial area that it has set and the transmitter side of the moving image (coding unit) may code the moving image whose resolution change has been controlled to generate a bitstream and contain the cropping position information in the bitstream.

In contrast, the receiver side of the moving image (cropping processing unit) may crop the reduced image on the basis of the cropping position information indicating the position for cropping the reduced image of the partial area from the frame. As described above, the cropping position information may be contained in the bitstream of the moving image. That is, the receiver side of the moving image (cropping processing unit) may crop the reduced image of the partial area on the basis of the cropping position information contained in the bitstream.

By transmitting the cropping position information in this manner, the cropping processing unit more easily and more correctly grasp the position and the size of the reduced image arranged in the frame (i.e., which position in the frame should be cropped) on the basis of the cropping position information. That is, the cropping processing unit is capable of more easily and more correctly cropping the reduced image.

It should be noted that specifications of the cropping position information are optional and the cropping position information may include any type of information as long as the information indicates the cropping position of the reduced image. For example, the cropping position information may include top, bottom, left, and right offsets of the arranged reduced image. Moreover, in a case of controlling the resolution change of the partial area, the reduced image of the partial area may be arranged at any position in the frame. For example, the reduced image of the partial area may be arranged at any position in the partial area. In that case, the cropping position information may include information indicating the position in the partial area. For example, the cropping position information may include offsets in top, bottom, left, and right directions of the reduced image in the partial area.

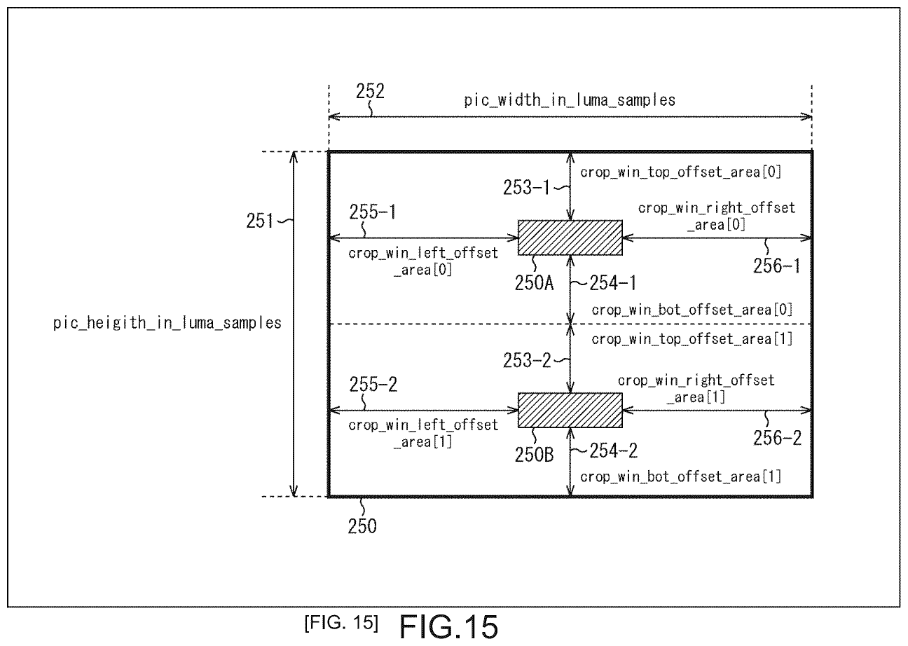

FIG. 15 is a diagram showing an example of the parameters included in the cropping position information. In FIG. 15, an example of the cropping position information in a case where a reduced image 250A and a reduced image 250B are arranged in a frame 250 is shown. The reduced image 250A is one obtained by reducing the size of an image of an area (area [0]) of the upper half of the frame 250. The reduced image 250B is one obtained by reducing the size of an image of an area (area [1]) of the lower half of the frame 250.

In a case of the example in FIG. 15, the cropping position information includes pic_height_in_luma_samples indicating a frame height (double arrow 251) and pic_width_in_luma_samples indicating a frame width (double arrow 252). Moreover, the cropping position information includes crop_win_top_offset_area [0] indicating an offset (double arrow 253-1) of the arranged reduced image 250A in the top direction in the partial area. Moreover, the cropping position information includes crop_win_bot_offset_area [0] indicating an offset (double arrow 254-1) of the arranged reduced image 250A in the bottom direction in the partial area. Moreover, the cropping position information includes crop_win_left_offset_area [0] indicating an offset (double arrow 255-1) of the arranged reduced image 250A in the left direction in the partial area. Moreover, the cropping position information includes crop_win_right_offset_area [0] indicating an offset (double arrow 256-1) of the arranged reduced image 250A in the right direction in the partial area. Moreover, the cropping position information includes crop_win_top_offset_area [1] indicating an offset (double arrow 253-2) of the arranged reduced image 250B in the top direction in the partial area. Moreover, the cropping position information includes crop_win_bot_offset_area [1] indicating an offset (double arrow 254-2) of the arranged reduced image 250B in the bottom direction in the partial area. Moreover, the cropping position information includes crop_win_left_offset_area [1] indicating an offset (double arrow 255-2) of the arranged reduced image 250B in the left direction in the partial area. Moreover, the cropping position information includes crop_win_right_offset_area [1] indicating an offset (double arrow 256-2) of the arranged reduced image 250B in the right direction in the partial area.

That is, in a case of this example, the range for cropping in the frame is indicated by the offsets of each reduced image in top, bottom, left, and right directions from the ends of the partial area corresponding to the reduced image.

It should be noted that the cropping position information may include, for example, the information indicating the position of the range for cropping in the frame and the information indicating the size of the cropping range. For example, the cropping position information may include the offsets of each reduced image in the top direction and the left direction (information indicating the position of the cropping range) from the ends of the partial area corresponding to the reduced image and the information indicating the height and the width of the cropping range. Moreover, the information indicating the position of the cropping range may be indicated by coordinates (e.g., center coordinates or the like) of a predetermined position of the cropping range.

In a case of storing the cropping position information as described above in the bitstream, a storage method therefor is optional. For example, in a case where the coding method for the moving image is HEVC, the cropping position information may be stored in SEI (user data unregistered SEI) for storing the user data. In that case, the cropping position information may be stored, associated with the frame.

For example, the cropping position information such as the above-mentioned frame size and offsets may be stored in the SEI in association with the POC of the frame.

### Control Based on Bandwidth of Transmission Channel

It should be noted that in a case of controlling the resolution change as described above on the basis of (fluctuations of) the bandwidth of the transmission channel, (fluctuations of) the bandwidth of the transmission channel may be one preceding the current time (in the past) or may be an estimated value (predicted one) of (fluctuations of) the bandwidth following the current time (in the future). Any method may be employed as an estimation method for (fluctuations of) the future bandwidth.

### 5. First Embodiment

### Image Transmitting Apparatus

The present technology described above can be applied to any apparatus, device, system, and the like. The present technology can be applied to, for example, an image transmitting apparatus that transmits a moving image.

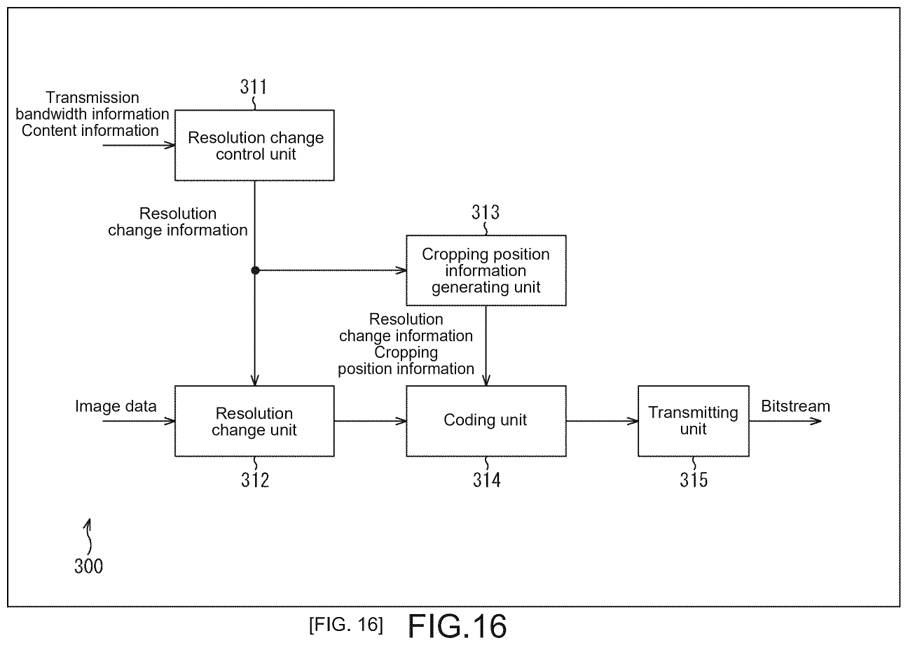

FIG. 16 is a block diagram showing an example of a configuration of an image transmitting apparatus that is an mode of the image processing apparatus to which the present technology is applied. An image transmitting apparatus 300 shown in FIG. 16 codes image data of a moving image and transmits coded data (bitstream) generated by the coding to the receiver side via a predetermined transmission channel. The transmission channel is optional and may be a wired transmission channel or may be a wireless transmission channel. Moreover, it may be one including a network or another communication apparatus.

It should be noted that in FIG. 16, main processing units, data flows, and the like are shown, and the present technology is not limited to those shown in FIG. 16. That is, in the image transmitting apparatus 300, processing units not shown as blocks in FIG. 16 may exist and flows of processing and data not shown as arrows and the like in FIG. 16 may exist.

As shown in FIG. 16, the image transmitting apparatus 300 includes a resolution change control unit 311, a resolution change unit 312, a cropping position information generating unit 313, a coding unit 314, and a transmitting unit 315.

The resolution change control unit 311 performs processing related to the control of the resolution change of the moving image. For example, the resolution change control unit 311 may acquire transmission bandwidth information, content information, and the like. The transmission bandwidth information is information regarding the bandwidth of the transmission channel that transmits the moving image. The transmission bandwidth information may be information indicating (fluctuations of) a past bandwidth of the transmission channel or may be an estimated value of (fluctuations of) a future bandwidth. Moreover, the content information may be information regarding the contents of content (the contents of a moving image to be transmitted) or may be a moving image to be transmitted itself.

Moreover, the resolution change control unit 311 may control the resolution change (the change in the reduction rate) on the basis of the acquired such information. At that time, the resolution change control unit 311 controls it by applying the present technology. That is, the resolution change control unit 311 performs control so that the resolution is changed in multiple steps. For example, the resolution change control unit 311 may control the resolution change by applying the above-mentioned various methods in <3. Multi-Step Control of Resolution Change in Frames>. Moreover, the resolution change control unit 311 may control the resolution change by applying the above-mentioned various methods in <4. Multi-Step Control of Resolution Change in Partial Areas>.

It should be noted that in a case where the resolution change control unit 311 controls the resolution change of the moving image on the basis of the estimated value (predicted one) of (fluctuations of) the bandwidth (in the future) following the current time, the estimated value may be indicated by the transmission bandwidth information or the resolution change control unit 311 may derive the estimated value on the basis of the transmission bandwidth information. That is, the resolution change control unit 311 may estimate a future bandwidth on the basis of a past bandwidth indicated by the transmission bandwidth information.

Moreover, the resolution change control unit 311 may generate the resolution change information indicating the control contents about the change in the resolution. That is, in that case, the resolution change control unit 311 generates resolution change information for performing control so that the change in the resolution is performed in multiple steps. Then, the resolution change control unit 311 may supply the generated resolution change information to the resolution change unit 312. Moreover, the resolution change control unit 311 may supply the generated resolution change information to the cropping position information generating unit 313.

The resolution change unit 312 performs the processing related to the change in the resolution. For example, the resolution change unit 312 may acquire the resolution change information supplied from the resolution change control unit 311. Moreover, the resolution change unit 312 may acquire the image data (moving image) to be transmitted.

The resolution change unit 312 controls the resolution of each frame image of the moving image on the basis of the resolution change information (i.e., in accordance with the control of the resolution change control unit 311). That is, the resolution change unit 312 reduces the size of the frame image of the moving image (the entire frame image or the partial area of the frame image) depending on needs. That is, it can also be said that the resolution change unit 312 is an image reduction unit. The reduction rate at that time is specified by the resolution change information. Alternatively, the resolution change unit 312 may derive the reduction rate of the frame image on the basis of the resolution change information.

As described above, the resolution change information indicates that the resolution is changed in multiple steps. In other words, the resolution change unit 312 changes the resolution of the frame image in the size reduction direction or the enlargement direction in multiple steps (increases or reduces the reduction rate in multiple steps).

Moreover, the resolution change unit 312 may supply each frame image of an input moving image ((the reduced image in a case where the entire part or a part of) the frame image is reduced in size) to the coding unit 314.

The cropping position information generating unit 313 performs processing related to generation of the cropping position information. For example, the cropping position information generating unit 313 may acquire the resolution change information supplied from the resolution change control unit 311.

Moreover, the cropping position information generating unit 313 may generate the cropping position information on the basis of the resolution change information (i.e., in accordance with the control of the resolution change control unit 311). In other words, the cropping position information generating unit 313 sets the position of the reduced image arranged in the frame. That is, it can also be said that the cropping position information generating unit 313 is a position setting unit. Moreover, the cropping position information generating unit 313 may supply the generated cropping position information to the coding unit 314 together with the resolution change information.

The coding unit 314 performs processing related to coding of the moving image. For example, the coding unit 314 may acquire the frame image of the moving image (or the reduced image) supplied from the resolution change unit 312. Moreover, the coding unit 314 may acquire the cropping position information and the resolution change information supplied from the cropping position information generating unit 313.

Moreover, the coding unit 314 may code the acquired moving image to generate coded data of the moving image (bitstream). Although any coding method may be applied to this coding, it is desirable to apply a coding method for a moving image using inter-prediction (inter-frame prediction), for example, advanced video coding (AVC), HEVC, or VVC, from the perspective of the coding efficiency. It should be noted that with respect to the frame for which the reduced image has been supplied, the coding unit 314 may arrange the reduced image in the frame on the basis of the cropping position information. That is, the coding unit 314 may arrange the reduced image at a position in the frame, which has been specified by the cropping position information generating unit 313. Then, the coding unit 314 may perform coding using the moving image of the predetermined frame size including the frame in which the reduced image is thus arranged as a single sequence to generate a bitstream.

Moreover, the coding unit 314 may store the cropping position information in the generated bitstream. Moreover, the coding unit 314 may store the resolution change information in the generated bitstream. Moreover, the coding unit 314 may supply the bitstream generated as described above to the transmitting unit 315.

The transmitting unit 315 performs processing related to transmission of the bitstream. For example, the transmitting unit 315 may acquire the bitstream supplied from the coding unit 314. The transmitting unit 315 may immediately (in real time) transmit the bitstream to the receiver side of the moving image (e.g., the image receiving apparatus to be described later) via the predetermined transmission channel. At that time, it is desirable that the transmitting unit 315 transmit the bitstream with less latency. It should be noted that the transmitting unit 315 may monitor (fluctuations of) the bandwidth of the transmission channel, generate transmission bandwidth information indicating (fluctuations of) the bandwidth, and supply the transmission bandwidth information to the resolution change control unit 311.

With such a configuration, the image transmitting apparatus 300 is capable of obtaining the above-mentioned effects in <3. Multi-Step Control of Resolution Change in Frames> or <4. Multi-Step Control of Resolution Change in Partial Areas>. That is, the image transmitting apparatus 300 is capable of suppressing a reduction in subjective image quality of the moving image.

### Flow of Image Transmitting Processing

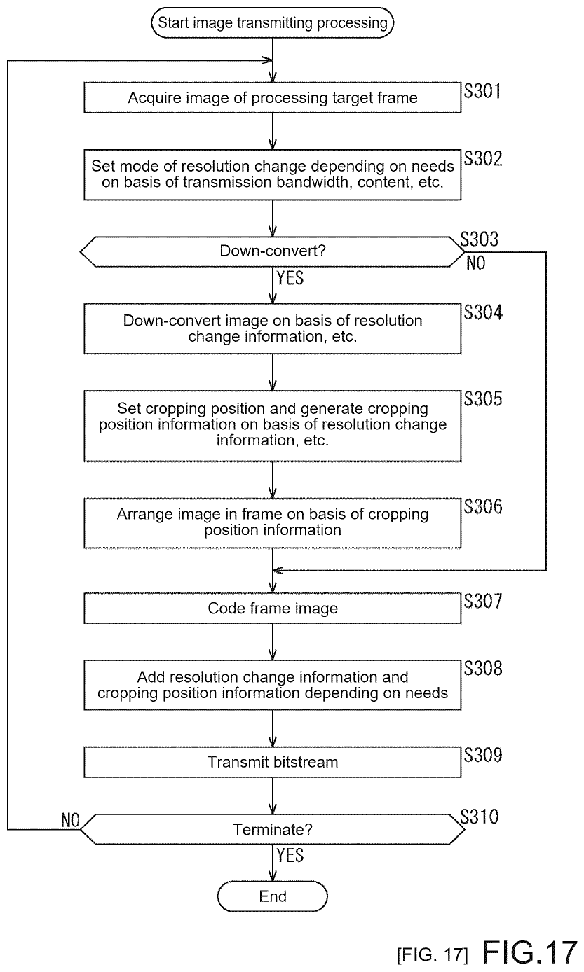

Next, a flow example of image transmitting processing executed by the image transmitting apparatus 300 will be described with reference to the flowchart in FIG. 17.

When the image transmitting processing is started, the resolution change unit 312 of the image transmitting apparatus 300 acquires, in Step S301, an image of a processing target frame.

In Step S302, the resolution change control unit 311 sets the mode of the resolution change and generates resolution change information depending on needs on the basis of the bandwidth of the transmission channel, the contents of the content, and the like. At that time, the resolution change control unit 311 may apply the above-mentioned various methods in <3. Multi-Step Control of Resolution Change in Frames>. Moreover, the resolution change control unit 311 may apply the above-mentioned various methods in <4. Multi-Step Control of Resolution Change in Partial Areas>.

In Step S303, the resolution change unit 312 determines whether or not to down-convert (reduce the size of) (the entire part or a part of) a frame image that is a processing target. In a case where it is determined to down-convert the frame image, the processing proceeds to Step S304.

In Step S304, the resolution change unit 312 down-converts (the entire part or a part of) the frame image that is the processing target to generate a reduced image on the basis of the resolution change information and the like.

In Step S305, the cropping position information generating unit 313 sets the cropping position of the reduced image and generates cropping position information on the basis of the resolution change information and the like.

In Step S306, the coding unit 314 arranges the reduced image (at the set position) in the frame on the basis of the cropping position information.

When the processing in Step S306 ends, the processing proceeds to Step S307. Moreover, in a case where it is in Step S303 determined not to down-convert the frame image, the processing proceeds to Step S307.

In Step S307, the coding unit 314 codes the frame image of the frame that is the processing target to generate a bitstream.

In Step S308, the coding unit 314 adds (stores) the resolution change information and the cropping position information to the bitstream depending on needs.

In Step S309, the transmitting unit 315 transmits the bitstream.

In Step S310, the transmitting unit 315 determines whether or not to terminate the image transmitting processing. In a case where it is determined to also transmit the next frame without terminating the image transmitting processing, the processing returns to Step S301 and executes the following processing. That is, the respective processes in Steps S301 to S310 are executed with respect to each frame of the moving image.

Then, in Step S310, in a case where it is determined that the transmission is terminated in this frame, the image transmitting processing ends.

By executing the respective processes as described above, the image transmitting apparatus 300 is capable of obtaining the above-mentioned effects in <3. Multi-Step Control of Resolution Change in Frames> or <4. Multi-Step Control of Resolution Change in Partial Areas>. That is, the image transmitting apparatus 300 is capable of suppressing a reduction in subjective image quality of the moving image.

### 6. Second Embodiment

### Image Receiving Apparatus

The present technology can be applied to, for example, an image receiving apparatus that receives coded data of a moving image.

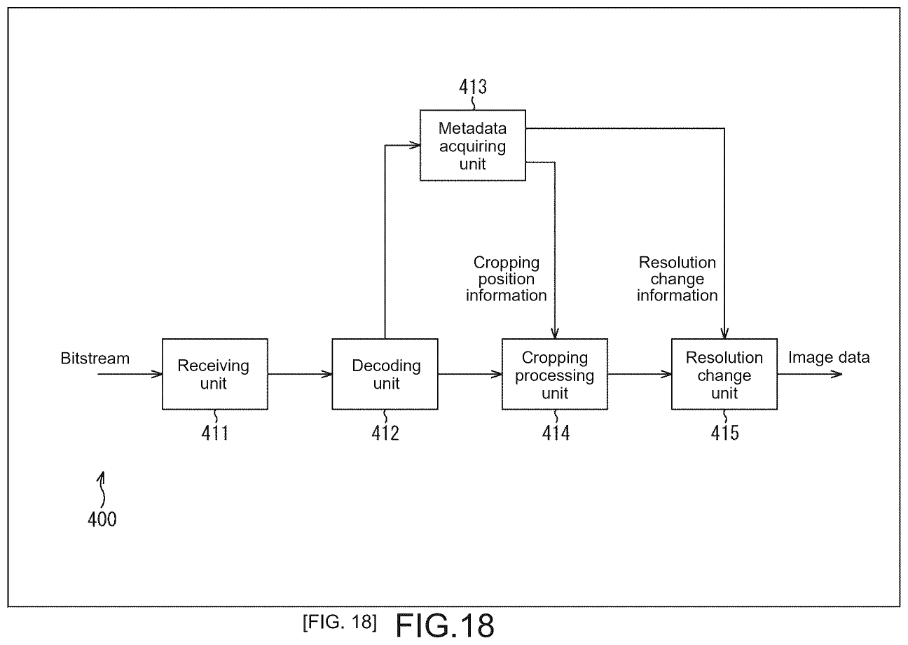

FIG. 18 is a block diagram showing an example of a configuration of an image receiving apparatus that is a mode of the image processing apparatus to which the present technology is applied. An image receiving apparatus 400 shown in FIG. 18 receives and decodes a bitstream and generates (restores) image data of a moving image. For example, the image receiving apparatus 400 receives and decodes the bitstream transmitted from the image transmitting apparatus 300 described above in the first embodiment.

It should be noted that in FIG. 18, main processing units, data flows, and the like are shown, and the present technology is not limited to those shown in FIG. 18. That is, in the image receiving apparatus 400, processing units not shown as blocks in FIG. 18 may exist and flows of processing and data not shown as arrows and the like in FIG. 18 may exist.

As shown in FIG. 18, the image receiving apparatus 400 includes a receiving unit 411, a decoding unit 412, a metadata acquiring unit 413, a cropping processing unit 414, and a resolution change unit 415.

The receiving unit 411 performs processing related to reception of the bitstream. For example, the receiving unit 411 may receive the bitstream of the moving image transmitted from the other apparatus. Moreover, the receiving unit 411 may supply the bitstream to the decoding unit 412 immediately (in real time). At that time, it is desirable that the receiving unit 411 supply to the bitstream the decoding unit 412 with less latency.

The decoding unit 412 performs processing related to decoding of the bitstream. For example, the decoding unit 412 may acquire a bitstream supplied from the receiving unit 411. Moreover, the decoding unit 412 may decodes the bitstream and generate (restore) (the frame image of) the moving image. Any decoding method may be applied to this decoding as long as it is compatible with the coding method applied for the coding. A decoding method for a moving image using inter-prediction (inter-frame prediction), for example, AVC, HEVC, or VVC, may be employed.

The decoding unit 412 may supply (the frame image of) the moving image generated (restored) to the cropping processing unit 414. Moreover, the decoding unit 412 may supply the acquired bitstream to the metadata acquiring unit 413.

The metadata acquiring unit 413 performs processing related to acquisition of the metadata. For example, the metadata acquiring unit 413 may acquire a bitstream supplied from the decoding unit 412. Moreover, the metadata acquiring unit 413 may extract metadata contained in the bitstream. For example, the metadata acquiring unit 413 may extract the cropping position information contained in the bitstream. In that case, the metadata acquiring unit 413 may supply the cropping position information to the cropping processing unit 414. Moreover, the metadata acquiring unit 413 may extract resolution change information contained in the bitstream. Moreover, the metadata acquiring unit 413 may supply the resolution change information to the resolution change unit 415.

The cropping processing unit 414 executes processing related to cropping of the reduced image. For example, the cropping processing unit 414 may acquire (the frame image of) the moving image supplied from the decoding unit 412. Moreover, the cropping processing unit 414 may acquire the cropping position information supplied from the metadata acquiring unit 413. Moreover, the cropping processing unit 414 may crop the reduced image on the basis of the cropping position information in a case where the reduced image is arranged in the frame that is the processing target. That is, the cropping processing unit 414 may extract the reduced image from a position of the frame, which has been specified by the cropping position information generating unit 313. Moreover, the cropping processing unit 414 may supply the cropped reduced image to the resolution change unit 415. It should be noted that in a case where the frame image of the frame that is the processing target is not reduced in size, the cropping processing unit 414 may supply the frame image to the resolution change unit 415.

The resolution change unit 415 performs processing related to the change in the resolution. For example, the resolution change unit 415 may acquire the frame image or the reduced image supplied from the cropping processing unit 414. Moreover, the resolution change unit 415 may acquire the resolution change information supplied from the metadata acquiring unit 413. Moreover, the resolution change unit 415 may enlarge the reduced image on the basis of the resolution change information. That is, it can also be said that the resolution change unit 415 is an image enlargement unit. For example, the resolution change unit 415 may generate the frame image of the frame size of the moving image by enlarging the reduced image of the entire frame image. Moreover, the resolution change unit 415 may generate the image of the partial area by enlarging the reduced image of the partial area of the frame image and generate the frame image of the frame size of the moving image by using the image of the partial area.

Moreover, the resolution change unit 415 may output the image data (the frame image of the moving image) generated as described above to the outside of the image receiving apparatus 400.

With such a configuration, the image receiving apparatus 400 is capable of obtaining the above-mentioned effects in <3. Multi-Step Control of Resolution Change in Frames> or <4. Multi-Step Control of Resolution Change in Partial Areas>. That is, the image receiving apparatus 400 is capable of suppressing a reduction in subjective image quality of the moving image.

### Flow of Image Receiving Processing

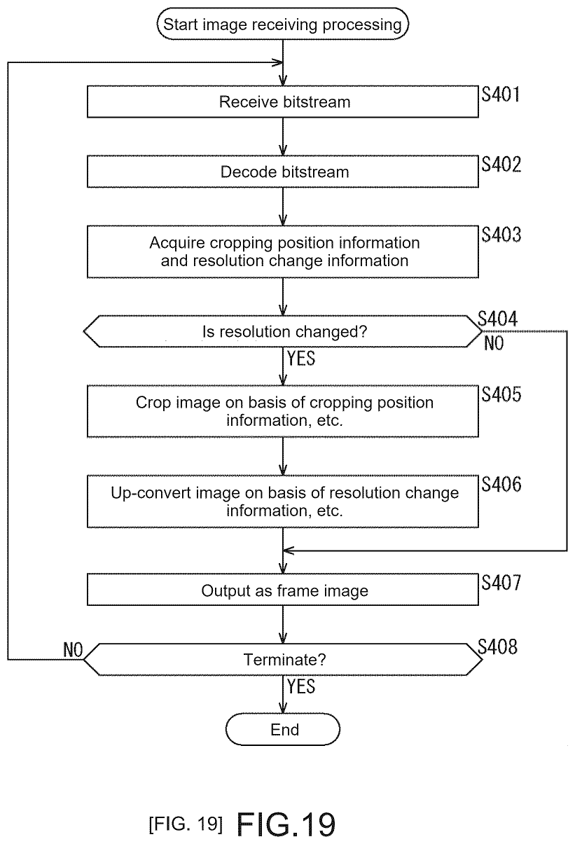

Next, a flow example of image receiving processing executed by the image receiving apparatus 400 will be described with reference to the flowchart in FIG. 19.

When the image receiving processing is started, the receiving unit 411 of the image receiving apparatus 400 receives, in Step S401, a bitstream.

In Step S402, the decoding unit 412 decodes the bitstream to generate (a frame image of) a moving image.

In Step S403, the metadata acquiring unit 413 acquires (extracts) cropping position information and resolution change information contained in the bitstream.

In Step S404, the cropping processing unit 414 determines whether or not (the entire part or a part of) the frame image is reduced in size with respect to a frame that is a processing target. In a case where it is determined that the image is reduced in size, the processing proceeds to Step S405.

In Step S405, the cropping processing unit 414 crops the arranged reduced image from the frame on the basis of the cropping position information.

In Step S406, the resolution change unit 415 up-converts (enlarges) the reduced image to generate the frame image of the frame size of the moving image on the basis of the resolution change information.

When the processing in Step S406 ends, the processing proceeds to Step S407. Moreover, in a case where it is in Step S404 determined that the frame image is not reduced in size in the frame that is the processing target, the processing proceeds to Step S407.

In Step S407, the resolution change unit 415 outputs the generated frame image or the frame image supplied from the cropping processing unit 414.

In Step S408, the receiving unit 411 determines whether or not to terminate the image receiving processing. In a case where the transmission of the moving image is continued and it is determined to also receive the bitstream of the next frame without terminating the image receiving processing, the processing returns to Step S401 and executes the following processing. That is, the respective processes in Steps S401 to S408 are executed with respect to each frame of the moving image. Then, in a case where it is in Step S408 determined not to receive the next frame, the image receiving processing ends.

By executing the respective processes as described above, the image receiving apparatus 400 is capable of obtaining the above-mentioned effects in <3. Multi-Step Control of Resolution Change in Frames> or <4. Multi-Step Control of Resolution Change in Partial Areas>. That is, the image receiving apparatus 400 is capable of suppressing a reduction in subjective image quality of the moving image.

### 7. Appendix

### Application Example

Any coding and decoding methods for the moving image are applied to the present technology. For example, multi-viewpoint image coding and decoding in which a multi-viewpoint image including images with a plurality of viewpoints (views) is coded may be applied. Moreover, layered image coding and decoding (scalable coding and scalable decoding) in which the moving image is layered into a plurality of layers and coded so as to provide a function of scalability for predetermined parameters may be applied.

### Regarding Terminology

It should be noted that in the present specification, the “flag” refers to information for identifying a plurality of states and includes not only information used for identifying two states, true (1) or false (0), but also information capable of identifying three or more states. Therefore, a value that the “flag” can take may be, for example, values, 1/0, or may be three or more values. That is, any number of bits constitutes the “flag” and a single bit or multiple bits may be employed. Moreover, as to the identification information (also including the flag), not only the form in which the identification information contains the bitstream, but also the form in which difference information of the identification information from certain reference information is contained in the bitstream are envisaged. Therefore, in the present specification, the “flag” or the “identification information” encompasses not only such information, but also difference information from reference information.

Moreover, various types of information (metadata and the like) regarding the coded data (bitstream) may be transmitted or recorded in any form as long as it is associated with the coded data. Here, the term “associate” means, for example, enabling one piece of data to be used (linked) when processing the other piece of data. That is, pieces of data associated with each other may be handled as one piece of data or may be individual separate pieces of data. For example, the information associated with the coded data (image) may be transmitted on a transmission channel other than the coded data (image). Moreover, for example, the information associated with the coded data (image) may be recorded on a recording medium other than the coded data (image) (or on another record area of the same recording medium). It should be noted that the “associating” may be performed on a part of data, not on the entire data. For example, an image and information corresponding to the image may be associated with each other in any units such as a plurality of frames, a single frame, or a part of a frame.

It should be noted that in the present specification, the terms “synthesize,” “multiplex,” “add,” “integrate,” “contain,” “store,” “incorporate,” “embed,” “insert,” etc., mean combining a plurality of objects into one, for example, combining the coded data and the metadata into one piece of data, and mean one of the above-mentioned “associating” methods.

### Computer

The above-mentioned series of processing may be executed by hardware or may be executed by software. If the series of processing is executed by software, programs that configure the software are installed in a computer. Here, the computer includes a computer incorporated in dedicated hardware, a general-purpose personal computer, for example, capable of executing various functions by installing various programs, and the like.

FIG. 25 is a block diagram showing a configuration example of hardware of the computer that executes the above-mentioned series of processing in accordance with the program.

In a computer 900 shown in FIG. 25, a central processing unit (CPU) 901, a read only memory (ROM) 902, and a random access memory (RAM) 903 are connected to one another through a bus 904.

An input/output interface 910 is also connected to the bus 904. An input unit 911, an output unit 912, a storage unit 913, a communication unit 914, and a drive 915 are connected to the input/output interface 910.

The input unit 911 includes, for example, a keyboard, a mouse, a microphone, a touch panel, and an input terminal. The output unit 912 includes, for example, a display, a loudspeaker, and an output terminal. The storage unit 913 includes, for example, a hard disk, a RAM disc, and a nonvolatile memory. The communication unit 914 includes, for example, a network interface. The drive 915 drives a removable medium 921 such as a magnetic disk, an optical disc, a magneto-optical disk, and a semiconductor memory.

In the thus configured computer, the CPU 901 loads, for example, programs stored in the storage unit 913 into the RAM 903 via the input/output interface 910 and the bus 904 and executes them. In this manner, the above-mentioned series of processing is performed. In the RAM 903, data necessary for the CPU 901 to execute various types of processing and the like are also stored as appropriate.

Programs executed by the computer can be, for example, provided recorded on the removable medium 921 that is a package medium. In that case, the program can be installed into the storage unit 913 via the input/output interface 910 by mounting the removable medium 921 on the drive 915.

Moreover, this program can be provided via a wired or wireless transmission medium such as a local area network, the Internet, and digital satellite broadcasting. In that case, the program can be received by the communication unit 914 and can be installed into the storage unit 913.

Otherwise, this program can be installed into the ROM 902 or the storage unit 913 in advance.

### Configurations to Which Present Technology Can Be Applied

The present technology can be applied to any configuration. For example, the present technology can be applied to various electronic apparatuses, such as transmitters and receivers (e.g., television receivers and mobile phones) for satellite broadcasting, wired broadcasting such as cable TV, distribution via the Internet, and distribution terminals via cellular communication and apparatuses (e.g., hard disk recorders and cameras) that record images on media such as optical discs, magnetic disks, and flash memories and play back images from these storage media.

Moreover, for example, the present technology can also be implemented as some configurations of the apparatus such as a processor (e.g., a video processor) serving as a system large scale integration (LSI) or the like, a module (e.g., a video module) using a plurality of processors and the like, a unit (e.g., a video unit) using a plurality of modules and the like, or a set (e.g., a video set) obtained by adding still other additional functions to the unit.

Moreover, for example, the present technology can also be applied to a network system which is constituted by a plurality of apparatuses. For example, the present technology may be implemented as cloud computing that is shared and commonly processed by the plurality of apparatuses via a network. For example, with respect to any terminal such as a computer, an audio visual (AV) apparatus, a portable information processing terminal, or an internet of things (IoT) device, the present technology may be implemented in a cloud service that provides a service related to an image (moving image).

It should be noted that in the present specification, the system means a set of a plurality of components (apparatuses, modules (parts), etc.), regardless of whether or not all the components are in the same casing. Therefore, a plurality of apparatuses that has been stored in separate casings and connected via a network and a single apparatus with a casing in which a plurality of modules has been stored are both the system.

### Fields and Applications to Which Present Technology Can Be Applied

Systems, apparatuses, processing units, and the like to which the present technology is applied can be used in any field, e.g., traffic, medical care, crime prevention, agriculture, livestock industry, mining industry, beauty care, factories, home electronics, weather, and natural monitor. In addition, they are used for any applications.

For example, the present technology can be applied to systems and devices provided for providing content to be viewed and the like. Moreover, for example, the present technology can also be applied to systems and devices provided for traffic such as monitoring traffic conditions and self-driving control. In addition, for example, the present technology can also be applied to systems and devices provided for security. Moreover, for example, the present technology can be applied to systems and devices provided for automatic control on machines and the like. In addition, for example, the present technology can also be applied to systems and devices provided for agriculture and livestock industry. Moreover, the present technology can also be applied to systems and devices that monitor, for example, the conditions of the nature such as volcanoes, forests, and oceans, wild animals, and the like. In addition, for example, the present technology can also be applied to systems and devices provided for sports.

### Others

Embodiments of the present technology are not limited to the above-mentioned embodiments and various modifications can be made without departing from the gist of the present technology.

For example, the configuration described as a single apparatus (or processing unit) may be divided to constitute it as a plurality of apparatuses (or processing units). On the contrary, configurations described above as a plurality of apparatuses (or processing units) may be combined and configured as the single apparatus (or the processing unit). Moreover, configurations other than those described above may be added to the configuration of each apparatus (or respective processing unit) as a matter of course. In addition, as long as the configurations and the operations are substantially the same as a whole of the system, some configurations of a certain apparatus (or processing unit) may be included in the configurations of the other apparatus (or the other processing unit).

Moreover, for example, the above-mentioned program may be executed in any apparatus. In that case, it is sufficient to enable the apparatus to have necessary functions (functional blocks, etc.) and be capable of obtaining necessary information.

Moreover, for example, the single apparatus may be enabled to execute the respective steps of a single flowchart so that the plurality of apparatuses shares and executes them. In addition, in a case where a single step includes a plurality of processes, the plurality of processes may be executed by the single apparatus and may be shared and executed by the plurality of apparatuses. In other words, the plurality of processes included in a single step may be executed as processing of a plurality of steps. On the contrary, the processing described as a plurality of steps may be combined and executed as a single step.

Moreover, for example, as to the program executed by the computer, the processing of the step of describing the program may be executed in chronological order according to the sequence described herein, or in parallel, or individually at a necessary timing such as when a call is made. That is, as long as no contradictions arise, the processing in the respective steps may be executed in an order different from the above-mentioned order. In addition, the processing of the step of describing this program may be provided executed in parallel with processing of another program or may be executed in combination with the processing of the other program.

Moreover, for example, a plurality of technologies related to the present technology can be each independently implemented alone as long as no contradictions arise. As a matter of course, any plurality of the present technologies can also be implemented in combination. For example, some or all of the present technologies described in any embodiment can also be implemented in combination with some or all of the present technologies described in the other embodiments. Moreover, a part of or the entire any present technology described above can also be implemented at the same time as other technologies not described above.

It should be noted that the present technology can also take the following configurations.
(1) An image processing apparatus, including:
a resolution change control unit that performs control on a moving image of a predetermined frame size so that a resolution of a frame image is changed in multiple steps;
an image reduction unit that generates a reduced image by reducing a size of the frame image of the moving image in accordance with the control of the resolution change control unit;
a position setting unit that sets a position of the reduced image to be arranged in a frame of the frame size; and
a coding unit that codes the moving image of the frame size including the frame in which the reduced image is arranged at the set position as a single sequence to generate a bitstream.
(2) The image processing apparatus according to (1), in which
the resolution change control unit controls an amount of change in the resolution.
(3) The image processing apparatus according to (2), in which
the resolution change control unit controls the amount of change in accordance with a bandwidth of a transmission channel.
(4) The image processing apparatus according to any of (1) to (3), in which
the resolution change control unit controls a length of a change period of the resolution.
(5) The image processing apparatus according to (4), in which
the resolution change control unit controls the length of the change period in accordance with a degree of change in a bandwidth of a transmission channel.
(6) The image processing apparatus according to (4) or (5), in which
the resolution change control unit controls the length of the change period in accordance with the moving image.
(7) The image processing apparatus according to any of (1) to (6), in which
the resolution change control unit controls the number of steps of the resolution change.
(8) The image processing apparatus according to any of (1) to (7), in which
the resolution change control unit controls a transition pattern of the resolution in the change in the resolution.
(9) The image processing apparatus according to (8), in which
the resolution change control unit controls the transition pattern in accordance with a degree of change in a bandwidth of a transmission channel.
(10) The image processing apparatus according to (8) or (9), in which
the resolution change control unit controls the transition pattern in accordance with the moving image.
(11) The image processing apparatus according to any of (1) to (10), in which
the resolution change control unit performs control to perform at least one of increase and reduction in an amount of change in the resolution in multiple steps.
(12) The image processing apparatus according to (11), in which
the resolution change control unit controls the increase and reduction in the amount of change in the resolution independently of each other.
(13) The image processing apparatus according to any of (1) to (12), in which
the resolution change control unit generates resolution change information indicating control contents about the change in the resolution, and
the coding unit contains the resolution change information in the bitstream.
(14) The image processing apparatus according to any of (1) to (13), in which
the position setting unit generates cropping position information indicating the set position, and
the coding unit contains the cropping position information in the bitstream.
(15) The image processing apparatus according to (14), in which
the cropping position information includes top, bottom, left, and right offsets of the arranged reduced image.
(16) The image processing apparatus according to any of (1) to (15), in which
the resolution change control unit controls the change in the resolution of the entire frame image.
(17) The image processing apparatus according to any of (1) to (15), in which
the resolution change control unit controls the change in the resolution of a partial area of the frame image.
(18) The image processing apparatus according to (17), in which
the resolution change control unit controls the change in the resolution of the partial area in accordance with an image of the partial area.
(19) The image processing apparatus according to (17) or (18), in which
the resolution change control unit performs control so that a resolution is changed from the partial area corresponding to a timing of a bandwidth fluctuation of a transmission channel.
(20) An image processing method, including:
performing control on a moving image of a predetermined frame size so that a resolution of a frame image is changed in multiple steps;
generating a reduced image by reducing a size of the frame image of the moving image in accordance with the control;
setting a position of the reduced image to be arranged in a frame of the frame size; and
coding the moving image of the frame size including the frame in which the reduced image is arranged at the set position as a single sequence to generate a bitstream.
(21) An image processing apparatus, including:
a decoding unit that decodes a bitstream to generate a moving image of a predetermined frame size;
a cropping processing unit that crops a reduced image in a frame of the moving image in which the reduced image is arranged, the reduced image being obtained by reducing a size of a partial area of a frame image; and
an image enlargement unit that enlarges the cropped reduced image to generate the frame image of the frame size.
(22) The image processing apparatus according to (21), in which
the cropping processing unit crops the reduced image on the basis of cropping position information indicating a position for cropping the reduced image from the frame.
(23) The image processing apparatus according to (22), in which
the cropping processing unit crops the reduced image on the basis of the cropping position information contained in the bitstream.
(24) The image processing apparatus according to any of (21) to (23), in which
the image enlargement unit enlarges the cropped reduced image on the basis of resolution change information indicating control contents about the change in the resolution of the reduced image.
(25) The image processing apparatus according to (24), in which
the image enlargement unit enlarges the reduced image on the basis of the resolution change information contained in the bitstream.
(26) An image processing method, including:
decoding a bitstream to generate a moving image of a predetermined frame size;
cropping a reduced image in a frame of the moving image in which the reduced image is arranged, the reduced image being obtained by reducing a size of a partial area of a frame image; and
enlarging the cropped reduced image to generate the frame image of the frame size.

### REFERENCE SIGNS LIST

300 image transmitting apparatus
311 resolution change control unit
312 resolution change unit
313 cropping position information generating unit
314 coding unit
315 transmitting unit
400 image receiving apparatus
411 receiving unit
412 decoding unit
413 metadata acquiring unit
414 cropping processing unit
415 resolution change unit

1. An image processing apparatus, comprising:
a resolution change control unit that performs control on a moving image of a predetermined frame size so that a resolution of a frame image is changed in multiple steps;
an image reduction unit that generates a reduced image by reducing a size of the frame image of the moving image in accordance with the control of the resolution change control unit;
a position setting unit that sets a position of the reduced image to be arranged in a frame of the frame size; and
a coding unit that codes the moving image of the frame size including the frame in which the reduced image is arranged at the set position as a single sequence to generate a bitstream.

2. The image processing apparatus according to claim 1, wherein
the resolution change control unit controls an amount of change in the resolution.

3. The image processing apparatus according to claim 2, wherein
the resolution change control unit controls the amount of change in accordance with a bandwidth of a transmission channel.

4. The image processing apparatus according to claim 1, wherein
the resolution change control unit controls a length of a change period of the resolution.

5. The image processing apparatus according to claim 4, wherein
the resolution change control unit controls the length of the change period in accordance with a degree of change in a bandwidth of a transmission channel.

6. The image processing apparatus according to claim 4, wherein
the resolution change control unit controls the length of the change period in accordance with the moving image.

7. The image processing apparatus according to claim 1, wherein
the resolution change control unit controls the number of steps of the resolution change.

8. The image processing apparatus according to claim 1, wherein
the resolution change control unit controls a transition pattern of the resolution in the change in the resolution.

9. The image processing apparatus according to claim 8, wherein
the resolution change control unit controls the transition pattern in accordance with a degree of change in a bandwidth of a transmission channel.

10. The image processing apparatus according to claim 8, wherein
the resolution change control unit controls the transition pattern in accordance with the moving image.

11. The image processing apparatus according to claim 1, wherein
the resolution change control unit performs control to perform at least one of increase and reduction in an amount of change in the resolution in multiple steps.

12. The image processing apparatus according to claim 11, wherein
the resolution change control unit controls the increase and reduction in the amount of change in the resolution independently of each other.

13. The image processing apparatus according to claim 1, wherein
the resolution change control unit generates resolution change information indicating control contents about the change in the resolution, and
the coding unit contains the resolution change information in the bitstream.

14. The image processing apparatus according to claim 1, wherein
the position setting unit generates cropping position information indicating the set position, and
the coding unit contains the cropping position information in the bitstream.

15. The image processing apparatus according to claim 14, wherein
the cropping position information includes top, bottom, left, and right offsets of the arranged reduced image.

16. The image processing apparatus according to claim 1, wherein
the resolution change control unit controls the change in the resolution of the entire frame image.

17. The image processing apparatus according to claim 1, wherein
the resolution change control unit controls the change in the resolution of a partial area of the frame image.

18. An image processing method, comprising:
performing control on a moving image of a predetermined frame size so that a resolution of a frame image is changed in multiple steps;
generating a reduced image by reducing a size of the frame image of the moving image in accordance with the control;
setting a position of the reduced image to be arranged in a frame of the frame size; and
coding the moving image of the frame size including the frame in which the reduced image is arranged at the set position as a single sequence to generate a bitstream.

19. An image processing apparatus, comprising:
a decoding unit that decodes a bitstream to generate a moving image of a predetermined frame size;
a cropping processing unit that crops a reduced image in a frame of the moving image in which the reduced image is arranged, the reduced image being obtained by reducing a size of a partial area of a frame image; and
an image enlargement unit that enlarges the cropped reduced image to generate the frame image of the frame size.

20. An image processing method, comprising:
decoding a bitstream to generate a moving image of a predetermined frame size;
cropping a reduced image in a frame of the moving image in which the reduced image is arranged, the reduced image being obtained by reducing a size of a partial area of a frame image; and
enlarging the cropped reduced image to generate the frame image of the frame size.
